(19) United States
(12) Patent Application Publication
(10) Pub. No.: US 2015/0170788 A1
(43) Pub. Date: Jun. 18, 2015

(54) Conductive Thermoplastic Compositions for Use in Tubular Applications

(71) Applicant: Ticona LLC, Florence, KY (US)

(72) Inventors: Kent Miller, Lexington, KY (US); Rong Luo, Florence, KY (US)

(21) Appl. No.: 14/573,741

(22) Filed: Dec. 17, 2014

Related U.S. Application Data
(60) Provisional application No. 61/917,571, filed on Dec. 18, 2013.

(51) Int. Cl. H01B 1/24; B32B 27/28; B32B 1/08

(52) U.S. Cl. CPC H01B 1/24; B32B 1/08; B32B 27/286; B32B 2307/202

(57) ABSTRACT

Conductive thermoplastic compositions are described that exhibit low permeability, high strength and flexibility. Methods for forming the thermoplastic compositions are also described. Formation methods include dynamic vulcanization of a thermoplastic composition that includes carbon nanotubes and an impact modifier dispersed throughout the polyarylene sulfide. A crosslinking agent is combined with the other components of the composition following dispersal of the impact modifier throughout the composition. The crosslinking agent reacts with the impact modifier to form crosslinks within and among the polymer chains of the impact modifier. The compositions can exhibit excellent physical characteristics at extreme temperatures and can be used to form conductive tubular member such as pipes and hoses and fibers.

### CROSS REFERENCE TO RELATED APPLICATION

This application claims filing benefit of U.S. Provisional Patent Application Ser. No. 61/917,571 having a filing date of Dec. 18, 2013, which is incorporated herein by reference.

### BACKGROUND OF THE INVENTION

Thermoplastic compositions that exhibit flexibility in addition to conductivity and low permeability are of significant commercial interest, for instance in the formation of pipes and tubes that carry combustible materials. Polymer blends for a variety of thermoplastic compositions have been formed in the past by uniformly mixing an elastic component with a thermoplastic polyolefin such that the elastomer is intimately and uniformly dispersed as a discrete or co-continuous phase within a continuous phase of the polyolefin. Vulcanization of the composite crosslinks the components and provides improved temperature and chemical resistance to the composition. When vulcanization is carried out during combination of the various polymeric components it is termed dynamic vulcanization. The inclusion of conductive additives as well as other beneficial components can provide desirable characteristics to the thermoplastic composition such as conductivity and reduced permeability.

Unfortunately, added components can also have detrimental effects on the thermoplastic composition. For example, to achieve conductivity, a high concentration of conductive additive such as carbon black is generally included in a composition. While providing the desired conductivity, the high loading level detrimentally affects the flexibility of the polymer composition, leading to a more brittle product.

Polyarylene sulfides are high-performance polymers that may withstand high thermal, chemical, and mechanical stresses and are beneficially utilized in a wide variety of applications. Polyarylene sulfides have often been blended with other polymers to improve characteristics of the product composition. For example, elastomeric impact modifiers have been found beneficial for improvement of the physical properties of a thermoplastic composition. Compositions including blends of polyarylene sulfides with impact modifying polymers have been considered for high performance, high temperature applications.

Unfortunately, elastomeric polymers generally considered useful for impact modification are not compatible with polyarylene sulfides and phase separation has been a problem in forming compositions of the two. Attempts have been made to improve the composition formation, for instance through the utilization of compatibilizers. However, even upon such modifications, compositions including polyarylene sulfides in combination with impact modifying polymers still fail to provide product performance as desired, particularly in applications that require both high heat resistance and high impact resistance.

What are needed in the art are thermoplastic compositions that exhibit the desirable characteristics of high performance polymers in conjunction with flexibility, conductivity and excellent permeation resistance, for instance for forming tubular members.

### SUMMARY OF THE INVENTION

Disclosed in one embodiment is a thermoplastic composition that includes a polyarylene sulfide and a crosslinked impact modifier in conjunction with carbon nanotubes. More specifically, the thermoplastic composition includes the carbon nanotubes in an amount from about 0.1% to about 5% by weight of the thermoplastic composition. The thermoplastic composition exhibits high toughness and good flexibility in addition to conductivity. For instance, the thermoplastic composition can exhibit a surface resistivity of about 10⁵ ohm or less.

Also disclosed are tubular members that can incorporate the thermoplastic composition such as pipes, tubes, and hoses. The tubular members can be suitable for carrying water, oil, gas, fuel, etc. In one particular embodiment, the tubular member can be a multi-layer structure and can include the thermoplastic composition in one or more of the layers of the member. For instance, the thermoplastic composition can form the inner layer of the multi-layer tubular member.

### BRIEF DESCRIPTION OF THE FIGURES

The present disclosure may be better understood with reference to the following figures:

FIG. 1 is a schematic representation of a process for forming the thermoplastic composition as disclosed herein.

FIG. 2 is a single layer tubular member as may be formed from the thermoplastic composition.

FIG. 3 illustrates a blow molding process as may be used in forming a tubular member that includes the thermoplastic composition.

FIG. 4 illustrates a continuous blow molding process as may be used in forming a tubular member that includes the thermoplastic composition.

FIG. 5 is a multi-layer tubular member, one or more layers of which may be formed from the thermoplastic composition.

FIG. 6 is a schematic representation of a multilayer riser including a barrier layer formed of the thermoplastic composition as described herein.

FIG. 7 illustrates a bundled riser including multiple flowlines as described herein.

FIG. 8 illustrates the effect of fuel soaking on surface resistivity as a function of time of a thermoplastic composition as described herein.

### DETAILED DESCRIPTION

It is to be understood by one of ordinary skill in the art that the present discussion is a description of exemplary embodiments only, and is not intended as limiting the broader aspects of the present disclosure.

The present disclosure is generally directed to thermoplastic compositions that can exhibit excellent strength and flexibility characteristics as well as conductivity and low permeability, and particularly low permeability to organic compounds such as fuels. Beneficially, the thermoplastic composition can maintain good physical characteristics even when utilized in extreme temperature applications. The thermoplastic composition can also maintain good physical characteristics under conditions in which the composition is subjected to extreme temperature fluctuations.

The thermoplastic composition can be formed according to a melt processing technique that includes combining a polyarylene sulfide with an impact modifier to form a mixture and subjecting the mixture to dynamic vulcanization. More specifically, the polyarylene sulfide can be combined with the impact modifier and this mixture can be subjected to shear conditions such that the impact modifier becomes well distributed throughout the polyarylene sulfide. Following formation of the mixture, a polyfunctional crosslinking agent can be added. The polyfunctional crosslinking agent can react with the components of the mixture to form crosslinks in the composition, for instance within and between the polymer chains of the impact modifier.

The formation process also includes combining an amount of carbon nanotubes with the polyarylene sulfide. The amount of nanotubes can be sufficient to encourage conductivity in the formed thermoplastic composition. Beneficially, the amount of carbon nanotubes can be such that the thermoplastic composition is conductive without excess loss of the flexibility of the composition. For instance, the composition can include the carbon nanotubes in an amount of from about 0.1% to about 5% by weight of the thermoplastic composition in some embodiments. In some embodiments, the thermoplastic composition can include carbon nanotubes in an amount of from about 1% to about 4.5% by weight of the composition, or from about 1.5% to about 4% by weight of the composition in some embodiments.

Without being bound to any particular theory, it is believed that by use of the carbon nanotubes a lower conductive additive level can be utilized while gaining excellent conductivity characteristics. This is believed to be due at least in part to the high aspect ratio of the carbon nanotubes. For instance, the carbon nanotubes can generally have an aspect ratio (length per diameter; LD) of 1 or greater, for instance about 2 or greater, about 5 or greater, about 10 or greater, about 50 or greater, or about 100 or greater, in some embodiments. Due to the high aspect ratio nanotubes a percolation network can be developed within the thermoplastic composition at lower additive levels as compared to previously considered additives that have a low aspect ratio particulate geometry such as carbon black. For instance, the thermoplastic composition can have a surface resistivity of about 10⁵ ohm or less in some embodiments, about 10⁴ ohm or less in some embodiments, about 10³ ohm or less in some embodiments, about 500 ohm or less in some embodiments, or about 200 ohm or less in some embodiments.

During formation of the thermoplastic composition the polyfunctional crosslinking agent is added following distribution of the impact modifier throughout the polyarylene sulfide. Thus, the impact modifier can be well distributed throughout the thermoplastic composition and the subsequently formed crosslinks can likewise be well distributed. In one embodiment the carbon nanotubes can also be added prior to the addition of the crosslinking agent. The improved distribution of the carbon nanotubes and the crosslinked impact modifier throughout the composition can improve the strength, permeability, and flexibility characteristics of the composition, e.g., the ability of the composition to maintain strength under deformation, as well as provide a composition with good conductivity at low nanotube concentration and good processibility that can be utilized to form a product that can exhibit excellent resistance to degradation under a variety of conditions.

According to one embodiment, a formation process can include functionalization of the polyarylene sulfide. This embodiment can provide additional sites for bonding between the impact modifier and the polyarylene sulfide, which can further improve distribution of the impact modifier throughout the polyarylene sulfide and further prevent phase separation. Moreover, functionalization of the polyarylene sulfide can include scission of the polyarylene sulfide chain, which can decrease the melt viscosity of the composition and improve processibility. This can also provide a thermoplastic composition that is a low halogen, e.g., low chlorine composition that exhibits excellent conductivity characteristics and high resistance to degradation.

To provide further improvements to the thermoplastic composition, the composition can be formed to include other conventional additives such as fillers, lubricants, colorants, etc. according to standard practice.

Permeation resistance can be important for a wide variety of applications for the thermoplastic composition, for instance when utilizing the composition in formation of fuel lines, or the like. The thermoplastic composition can exhibit excellent permeation resistance to a wide variety of materials. For instance, a shaped product formed of the thermoplastic composition can exhibit a permeation resistance to a fuel or a fuel source (e.g., gasoline, diesel fuel, jet fuel, unrefined or refined oil, etc.) of less than about 10 g-mm/m²-day, less than about 5 g-mm/m²-day, less than about 3 g-mm/m²-day, or less than about 2 g-mm/m²-day. By way of example, the thermoplastic composition (or a product formed of the thermoplastic composition) can exhibit a permeation resistance to an ethanol blend of ethanol/iso-octane/toluene at a weight ratio of 10:45:45 at 40° C. of less than about 10 g-mm/m²-day, less than about 3 g-mm/m²-day, less than about 2.5 g-mm/m²-day, less than about 1 g-mm/m²-day, or less than about 0.1 g-mm/m²-day. The permeation resistance to a blend of 15 wt. % methanol and 85 wt. % oxygenated fuel (CM15A) at 40° C. can be less than about 5 g-mm/m²-day, less than about 3 g-mm/m²-day, less than about 2.5 g-mm/m²-day, less than about 1 g-mm/m²-day, less than about 0.5 g-mm/m²-day, less than about 0.3 g-mm/m²-day, or less than about 0.15 g-mm/m²-day. The permeation resistance to methanol at 40° C. can be less than about 1 g-mm/m²-day, less than about 0.5 g-mm/m²-day, less than about 0.25 g-mm/m²-day, less than about 0.1 g-mm/m²-day, or less than about 0.06 g-mm/m²-day. Permeation resistance can be determined according to SAE Testing Method No. J2665. In addition, the thermoplastic composition can maintain original density following long term exposure to hydrocarbons. For example, the composition can maintain greater than about 95% of original density, greater than about 96% of original density, such as about 99% of original density following long term (e.g., greater than about 14 days) exposure to hydrocarbons such as heptane, cyclohexane, toluene, and so forth, or combinations of hydrocarbons.

The thermoplastic composition can also be resistant to uptake of materials, and specifically hydrocarbons. For example, a tubular member formed of the composition can exhibit a volume change of less than about 25%, less than about 20%, or less than about 14% following exposure to the hydrocarbon at a temperature of 130° C. for a period of time of about two weeks.

The resistance of the thermoplastic composition to uptake of hydrocarbons is also evident through the low levels of extracted hydrocarbons following exposure. For instance, following refluxing in ethanol for 18 hours according to SAE J2260, the extractable hydrocarbon content of the thermoplastic composition can be less than about 1 wt. % of the thermoplastic composition in some embodiments, or less than about 0.5 wt. % in some embodiments, or less than about 0.3 wt. % in some embodiments, or less than about 0.2 wt. % in some embodiments.

Tubular members formed of the thermoplastic composition can exhibit excellent characteristic for use as fuel lines, etc. For instance, an 8 millimeter (mm) outside diameter (OD) tubular member can have a burst pressure (ambient) of about 900 pounds per square inch (psi) (about 6 megapascals (MPa)) or greater, about 1200 psi (about 8 MPa) or greater, about 1250 psi (about 8.5 MPa) or greater, or about 1300 psi (about 9 MPa) or greater, in some embodiments. An 8 mm OD tubular member can have a burst pressure (115° C.) of about 290 psi (about 2 MPa) or greater, about 600 psi (about 4 MPa) or greater, about 750 psi (about 5 MPa) or greater, about 900 psi (about 6 MPa) or greater or about 950 psi (about 6.5 MPa) or greater, in some embodiments. An 8 mm OD tubular member can have a burst pressure (150° C.) of about 290 psi (about 2 MPa) or greater, about 400 psi (about 3 MPa) or greater, about 500 psi (about 3.5 MPa) or greater, about 600 psi (about 4 MPa) or greater, about 700 psi (about 4.5 MPa) or greater, or about 800 psi (about 5.5 MPa) or greater, in some embodiments. An 8 mm OD tubular member can have a kink and burst pressure of about 75% of the ambient burst pressure; for instance about 650 psi (about 4.5 MPa) or greater, about 1200 psi (about 8 MPa) or greater, about 1300 psi (about 9 MPa) or greater, or about 1400 psi (about 9.5 MPa) or greater, in some embodiments. An 8 mm OD tubular member can have a burst pressure after cold impact of about 1200 psi (about 8 MPa) or greater, about 1250 psi (about 8.5 MPa) or greater, or about 1300 psi (about 9 MPa) or greater, in some embodiments. Burst pressure characteristics can be determined according to SAE J2260, as is known in the art.

Tubular members that include the thermoplastic composition can also exhibit excellent pull off characteristics as determined according to SAE J2260. For instance, an 8 MM OD tubular member can exhibit an ambient pull off of about 450 Newtons (N) or greater, about 500 N or greater, about 600 N or greater, about 700 N or greater, or about 750 N or greater, in some embodiments. An 8 mm OD tubular member can exhibit a pull off at 85° C. of about 115 N or greater, about 300 N or greater, about 400 N or greater, about 500 N or greater, or about 550 N or greater, in some embodiments.

The high strength and flexibility characteristics of the thermoplastic composition can be evident by examination of the tensile, flexural, and/or impact properties of the materials. For example, the thermoplastic composition can have a notched Charpy impact strength of greater than about 3 kJ/m², greater than about 3.5 kJ/m², greater than about 5 kJ/m², greater than about 10 kJ/m², greater than about 15 kJ/m², greater than about 30 kJ/m², greater than about 33 kJ/m², greater than about 40 kJ/m², greater than about 45 kJ/m², or greater than about 50 kJ/m² as determined according to ISO Test No. 179-1 (technically equivalent to ASTM D256, Method B) at 23° C. The unnotched Charpy samples do not break under testing conditions of ISO Test No. 180 at 23° C. (technically equivalent to ASTM D256).

Beneficially, the thermoplastic composition can maintain good physical characteristics even at extreme temperatures, including both high and low temperatures. For instance, the thermoplastic composition can have a notched Charpy impact strength of greater than about 8 kJ/m², greater than about 9 kJ/m², greater than about 10 kJ/m², greater than about 14 kJ/m², greater than about 15 kJ/m², greater than about 18 kJ/m², or greater than about 20 kJ/m² as determined according to ISO Test No. 179-1 at −30° C.; and can have a notched Charpy impact strength of greater than about 8 kJ/m², greater than about 9 kJ/m², greater than about 10 kJ/m², greater than about 11 kJ/m², greater than about 12 kJ/m², or greater than about 15 kJ/m² as determined according to ISO Test No. 179-1 at −40° C.

Moreover, the effect of temperature change on the thermoplastic composition can be surprisingly small. For instance, the ratio of the notched Charpy impact strength as determined according to ISO Test No. 179-1 at 23° C. to that at −30° C. can be greater than about 3.5, greater than about 3.6, or greater than about 3.7. Thus, and as described in more detail in the example section below, as the temperature increases the impact strength of the thermoplastic composition also increases, as expected, but the rate of increase of the impact strength is very high, particularly as compared to a composition that does not include the dynamically crosslinked impact modifier. Accordingly, the thermoplastic composition can exhibit excellent strength characteristics at a wide range of temperatures.

The thermoplastic composition can exhibit very good tensile characteristics. For example, the thermoplastic composition can have a tensile elongation at yield of greater than about 4.5%, greater than about 6%, greater than about 7%, greater than about 10%, greater than about 25%, greater than about 35%, greater than about 50%, greater than about 70%, greater than about 75%, greater than about 80%, or greater than about 90%. Similarly, the tensile elongation at break can be quite high, for instance greater than about 10%, greater than about 25%, greater than about 35%, greater than about 50%, greater than about 70%, greater than about 75%, greater than about 80%, or greater than about 90%. The strain at break can be greater than about 5%, greater than about 15%, greater than about 20%, or greater than about 25%. For instance the strain at break can be about 90%. The yield strain can likewise be high, for instance greater than about 5%, greater than about 15%, greater than about 20%, or greater than about 25%. The yield stress can be, for example, greater than about 50% or greater than about 53%. The thermoplastic composition may have a tensile strength at break of greater than about 30 MPa, greater than about 35 MPa, greater than about 40 MPa, greater than about 45 MPa, or greater than about 70 MPa.

In addition, the thermoplastic composition can have a relatively low tensile modulus. For instance, the thermoplastic composition can have a tensile modulus less than about 3000 MPa, less than about 2300 MPa, less than about 2000 MPa, less than about 1500 MPa, or less than about 1100 MPa as determined according to ISO Test No. 527 at a temperature of 23° C. and a test speed of 5 mm/min.

The thermoplastic composition can exhibit good characteristics after annealing as well. For instance, following annealing at a temperature of about 230° C. for a period of time of about 2 hours, the tensile modulus of the composition can be less than about 2500 MPa, less than about 2300 MPa, or less than about 2250 MPa. The tensile strength at break after annealing can be greater than about 50 MPa, or greater than about 55 MPa, as measured according to ISO Test No. 527 at a temperature of 23° C. and a test speed of 5 mm/min.

The thermoplastic composition can also be utilized continuously at high temperature, for instance at a continuous use temperature of up to about 150° C., about 160° C., or about 165° C. without loss of tensile strength. For example, the thermoplastic composition can maintain greater than about 95%, for instance about 100% of the original tensile strength after 1000 hours of heat aging at 135° C. and can maintain greater than about 95%, for instance about 100% of the original tensile elongation at yield after 1000 hours heat aging at 135° C.

The thermoplastic composition can exhibit little dimensional change after heat aging. For instance, following heat aging of a tubular member for 24 hours at 160° C. as described by SAE J2260, the tubular member can exhibit a length change of about 2% or less, about 1% or less, about 0.9% or less, about 0.7% or less, about 0.5% or less, or about 0.4% or less, in some embodiments; the tubular member can exhibit an outside diameter change of about 0.5% or less, about 0.4% or less, about 0.3% or less, or about 0.2% or less, in some embodiments; and the tubular member can exhibit a change in wall thickness of about 1% or less, about 0.8% or less, about 0.5% or less or about 0.3% or less in some embodiments.

Tensile characteristics can be determined according to ISO Test No. 527 at a temperature of 23° C. and a test speed of 5 mm/min or 50 mm/min (technically equivalent to ASTM D623 at 23° C.).

The flexural characteristics of the composition can be determined according to ISO Test No. 178 (technically equivalent to ASTM D790 at a temperature of 23° C. and a testing speed of 2 mm/min. For example, the flexural modulus of the composition can be less than about 2500 MPa, less than about 2300 MPa, less than about 2000 MPa, less than about 1800 MPa, or less than about 1500 MPa. The thermoplastic composition may have a flexural strength at break of greater than about 30 MPa, greater than about 35 MPa, greater than about 40 MPa, greater than about 45 MPa, or greater than about 70 MPa.

The deflection temperature under load of the thermoplastic composition can be relatively high. For example, the deflection temperature under load of the thermoplastic composition can be greater than about 80° C., greater than about 90° C., greater than about 100° C., or greater than about 105° C., as determined according to ISO Test No. 75-2 (technically equivalent to ASTM D790) at 1.8 MPa.

The Vicat softening point can be greater than about 200° C. or greater than about 250° C., for instance about 270° C. as determined according to the Vicat A test when a load of 10 N is used at a heating rate of 50 K/hr. For the Vicat B test, when a load of 50 N is used at a heating rate of 50 K/hr, the Vicat softening point can be greater than about 100° C., greater than about 150° C. greater than about 175° C., or greater than about 190° C., for instance about 200° C. The Vicat softening point can be determined according to ISO Test No. 306 (technically equivalent to ASTM D1525).

The thermoplastic composition can also exhibit excellent stability during long term exposure to harsh environmental conditions. For instance, under long term exposure to an acidic environment, the thermoplastic composition can exhibit little loss in strength characteristics. For instance, following 500 hours exposure to a strong acid (e.g., a solution of about 5% or more strong acid such as sulfuric acid, hydrochloric acid, nitric acid, perchloric acid, etc.), the thermoplastic composition can exhibit a loss in Charpy notched impact strength of less than about 17%, or less than about 16% following exposure of about 500 hours to a strong acid solution at a temperature of about 40° C., and can exhibit a loss in Charpy notched impact strength of less than about 25%, or less than about 22% following exposure of about 500 hours to a strong acid solution at a temperature of about 80° C. Even under harsher conditions, for instance in a 10% sulfuric acid solution held at a temperature of about 80° C. for 1000 hours, the thermoplastic composition can maintain about 80% or more of the initial Charpy notched impact strength.

The thermoplastic composition can also maintain desirable strength characteristics following exposure to other potentially degrading materials, such as salts, e.g., road salts as may be encountered in automotive applications. For instance, in a road salt test according to SAE J2260, the thermoplastic composition can exhibit a Charpy Unnotched Impact Strength after exposure to calcium chloride of about 200 kilojoules per square meter (kJ/m²) or greater, for instance about 210 kJ/m² or greater, about 220 kJ/m² or greater, or about 230 kJ/m² or greater, in some embodiments.

The thermoplastic composition can exhibit good heat resistance and flame retardant characteristics. For instance, the composition can meet the V-0 flammability standard at a thickness of 0.2 millimeters. The flame retarding efficacy may be determined according to the UL 94 Vertical Burn Test procedure of the “Test for Flammability of Plastic Materials for Parts in Devices and Appliances”, 5th Edition, Oct. 29, 1996. The ratings according to the UL 94 test are listed in the following table:

| Rating | Afterflame Time (s) | Burning Drips | Burn to Clamp |
|---|---|---|---|
| V-0 | <10 | No | No |
| V-1 | <30 | No | No |
| V-2 | <30 | Yes | No |
| Fail | <30 | | Yes |
| Fail | >30 | | No |

The “afterflame time” is an average value determined by dividing the total afterflame time (an aggregate value of all samples tested) by the number of samples. The total afterflame time is the sum of the time (in seconds) that all the samples remained ignited after two separate applications of a flame as described in the UL-94 VTM test. Shorter time periods indicate better flame resistance, i.e., the flame went out faster. For a V-0 rating, the total afterflame time for five (5) samples, each having two applications of flame, must not exceed 50 seconds. Using the flame retardant of the present invention, articles may achieve at least a V-1 rating, and typically a V-0 rating, for specimens having a thickness of 0.2 millimeters.

The thermoplastic composition can also exhibit good processing characteristics, for instance as demonstrated by the melt viscosity of the composition. For instance, the thermoplastic composition can have a melt viscosity of less than about 6000 poise, or less than about 4000 poise in some embodiments, as determined in accordance with ISO Test No. 11443 at a shear rate of 1200 s⁻¹ and at a temperature of 310° C. Moreover, the thermoplastic composition can exhibit improved melt stability over time as compared to thermoplastic compositions that do not include crosslinked impact modifiers. Thermoplastic compositions that do not include a crosslinked impact modifier tend to exhibit an increase in melt viscosity over time, and in contrast, disclosed compositions can maintain or even decrease in melt viscosity over time.

The thermoplastic composition can have a complex viscosity as determined at low shear (0.1 radians per second (rad/s)) and 310° C. of greater than about 10 kPa/sec, greater than about 25 kPa/sec, greater than about 40 kPa/sec, greater than about 50 kPa/sec, greater than about 75 kPa/sec, greater than about 200 kPa/sec, greater than about 250 kPa/sec, greater than about 300 kPa/sec, greater than about 350 kPa/sec, greater than about 400 kPa/sec, or greater than about 450 kPa/sec. Higher value for complex viscosity at low shear is indicative of the crosslinked structure of the composition and the higher melt strength of the thermoplastic composition. In addition, the thermoplastic composition can exhibit high shear sensitivity, which indicates excellent characteristics for use in formation processes such as blow molding and extrusion processing.

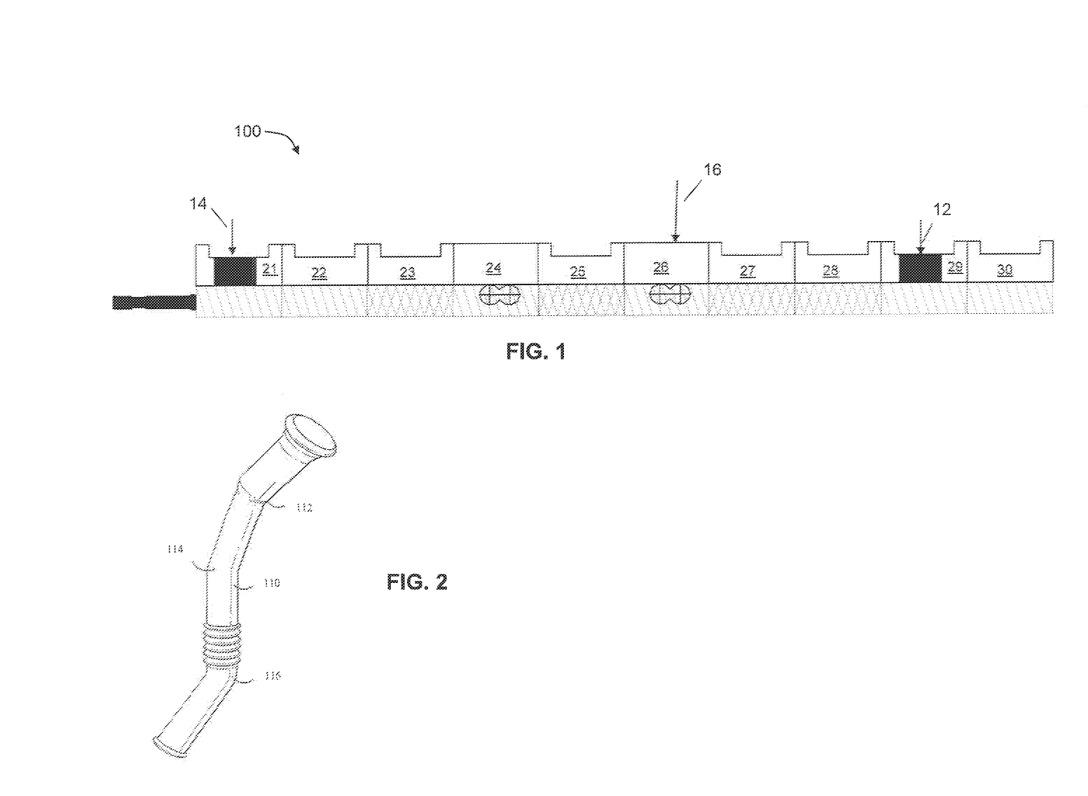

FIG. 1 illustrates a schematic of a process that can be used in forming the thermoplastic composition. As illustrated, the components of the thermoplastic composition may be melt-kneaded in a melt processing unit such as an extruder 100. Extruder 100 can be any extruder as is known in the art including, without limitation, a single, twin, or multi-screw extruder, a co-rotating or counter rotating extruder, an intermeshing or non-intermeshing extruder, and so forth. In one embodiment, the composition may be melt processed in an extruder 100 that includes multiple zones or barrels. In the illustrated embodiment, extruder 100 includes 10 barrels numbered 21-30 along the length of the extruder 100, as shown. Each barrel 21-30 can include feed lines 14, 16, vents 12, temperature controls, etc. that can be independently operated. A general purpose screw design can be used to melt process the polyarylene composition. By way of example, a thermoplastic composition may be melt mixed using a twin screw extruder such as a Coperion co-rotating fully intermeshing twin screw extruder.

In forming a thermoplastic composition, the polyarylene sulfide can be fed to the extruder 100 at a main feed throat 14. For instance, the polyarylene sulfide may be fed to the main feed throat 14 at the first barrel 21 by means of a metering feeder. The polyarylene sulfide can be melted and mixed with the other components of the composition as it progresses through the extruder 100. The impact modifier and the carbon nanotubes can be added to the composition in conjunction with the thermoplastic composition at the main feed throat 14 or downstream of the main feed throat either together or separately, as desired.

At a point downstream of the main feed throat 14, and following addition of the impact modifier to the composition, the crosslinking agent can be added to the composition. For instance, in the illustrated embodiment, a second feed line 16 at barrel 26 can be utilized for addition of the crosslinking agent. The point of addition for the crosslinking agent is not particularly limited. However, the crosslinking agent can be added to the composition at a point after the polyarylene sulfide has been mixed with the impact modifier under shear such that the impact modifier is well distributed throughout the polyarylene sulfide.

The carbon nanotubes can be added either prior to or following the addition of the crosslinking agent. For instance, the carbon nanotubes can be added at the main feed throat 14 of the system of FIG. 1 in conjunction with the polyarylene sulfide, or downstream, for instance at feed line 16 that is downstream of the main feed throat 14. The carbon nanotubes can be added prior to, in conjunction with, or following addition of other additives such as the impact modifier and the crosslinking agent. Alternatively, the carbon nanotubes can be added in conjunction with other additives, such as a lubricant, as will be discussed further within this disclosure.

The term “carbon nanotube” generally refers to a nanostructure containing at least one layer of graphene in the shape of a hollow cylinder. The cylinder may be rolled at specific and discrete chiral angles and may be capped at one or both ends to form a fullerene. The carbon nanotubes may contain only one graphene monolayer, in which case they are known as single-wall nanotubes (“SWNT”). The carbon nanotubes may also be a coaxial assembly of several single-wall nanotubes of different diameters, in which case they are generally known as multi-wall nanotubes (MWNT). Multi-wall nanotubes are particularly suitable for use in the present invention that include, for instance, from 2 to 100, and in some embodiments, from 5 to 50 coaxial single-wall nanotubes. Such multi-wall nanotubes are commercially available under the trade designation Nanocyl®. Nanocyl® NC210 and NC7000, for instance, are multi-walled nanotubes having average diameters of 3.5 nanometers and 9.5 nanometers, respectively (with lengths between 1 and 10 micrometers).

Any of a variety of known techniques may be employed to form the carbon nanotubes, such as catalytic carbon vapor deposition. Regardless, the resulting carbon nanotubes typically have a high carbon purity level to provide a more controlled and narrow size distribution. For example, the carbon purity may be about 80% or more, in some embodiments about 85% or more, and in some embodiments, from about 90% to 100%. If desired, the carbon nanotubes may optionally be chemically modified by functional groups to improve, for example, their hydrophilic character. Suitable functional groups may include, for instance, carboxyl groups, amine groups, thiol groups, hydroxy groups, etc.

The polyarylene sulfide may be a polyarylene thioether containing repeat units of the formula (I):

—[(Ar¹)ₙ—X]ₘ—[(Ar²)ᵢ—Y]ⱼ—[(Ar³)ₖ—Z]ₗ—[(Ar⁴)ₒ—W]ₚ— (I)

wherein Ar¹, Ar², Ar³, and Ar⁴ are the same or different and are arylene units of 6 to 18 carbon atoms; W, X, Y, and Z are the same or different and are bivalent linking groups selected from —SO₂—, —S—, —SO—, —CO—, —O—, —COO— or alkylene or alkylidene groups of 1 to 6 carbon atoms and wherein at least one of the linking groups is —S—; and n, m, i, j, k, l, o, and p are independently zero or 1, 2, 3, or 4, subject to the proviso that their sum total is not less than 2. The arylene units Ar¹, Ar², Ar³, and Ar⁴ may be selectively substituted or unsubstituted. Advantageous arylene systems are phenylene, biphenylene, naphthylene, anthracene and phenanthrene. The polyarylene sulfide typically includes more than about 30 mol %, more than about 50 mol %, or more than about 70 mol % arylene sulfide (—S—) units. In one embodiment the polyarylene sulfide includes at least 85 mol % sulfide linkages attached directly to two aromatic rings.

In one embodiment, the polyarylene sulfide is a polyphenylene sulfide, defined herein as containing the phenylene sulfide structure —(C₆H₄—S)ₙ— (wherein n is an integer of 1 or more) as a component thereof.

The polyarylene sulfide may be synthesized prior to forming the thermoplastic composition, though this is not a requirement of a process. For instance Fortron® polyphenylene sulfide available from Ticona of Florence, Ky., USA can be purchased and utilized as the polyarylene sulfide.

Synthesis techniques that may be used in making a polyarylene sulfide are generally known in the art. By way of example, a process for producing a polyarylene sulfide can include reacting a material that provides a hydrosulfide ion, e.g., an alkali metal sulfide, with a dihaloaromatic compound in an organic amide solvent.

The alkali metal sulfide can be, for example, lithium sulfide, sodium sulfide, potassium sulfide, rubidium sulfide, cesium sulfide or a mixture thereof. When the alkali metal sulfide is a hydrate or an aqueous mixture, the alkali metal sulfide can be processed according to a dehydrating operation in advance of the polymerization reaction. An alkali metal sulfide can also be generated in situ. In addition, a small amount of an alkali metal hydroxide can be included in the reaction to remove or react impurities (e.g., to change such impurities to harmless materials) such as an alkali metal polysulfide or an alkali metal thiosulfate, which may be present in a very small amount with the alkali metal sulfide.

The dihaloaromatic compound can be, without limitation, an o-dihalobenzene, m-dihalobenzene, p-dihalobenzene, dihalotoluene, dihalonaphthalene, methoxy-dihalobenzene, dihalobiphenyl, dihalobenzoic acid, dihalodiphenyl ether, dihalodiphenyl sulfone, dihalodiphenyl sulfoxide or dihalodiphenyl ketone. Dihaloaromatic compounds may be used either singly or in any combination thereof. Specific exemplary dihaloaromatic compounds can include, without limitation, p-dichlorobenzene; m-dichlorobenzene; o-dichlorobenzene; 2,5-dichlorotoluene; 1,4-dibromobenzene; 1,4-dichloronaphthalene; 1-methoxy-2,5-dichlorobenzene; 4,4′-dichlorobiphenyl; 3,5-dichlorobenzoic acid; 4,4′-dichlorodiphenyl ether; 4,4′-dichlorodiphenylsulfone; 4,4′-dichlorodiphenylsulfoxide; and 4,4′-dichlorodiphenyl ketone.

The halogen atom can be fluorine, chlorine, bromine or iodine, and 2 halogen atoms in the same dihalo-aromatic compound may be the same or different from each other. In one embodiment, o-dichlorobenzene, m-dichlorobenzene, p-dichlorobenzene or a mixture of 2 or more compounds thereof is used as the dihalo-aromatic compound.

As is known in the art, it is also possible to use a monohalo compound (not necessarily an aromatic compound) in combination with the dihaloaromatic compound in order to form end groups of the polyarylene sulfide or to regulate the polymerization reaction and/or the molecular weight of the polyarylene sulfide.

The polyarylene sulfide may be a homopolymer or may be a copolymer. By a suitable, selective combination of dihaloaromatic compounds, a polyarylene sulfide copolymer can be formed containing not less than two different units. For instance, in the case where p-dichlorobenzene is used in combination with m-dichlorobenzene or 4,4′-dichlorodiphenylsulfone, a polyarylene sulfide copolymer can be formed containing segments having the structure of formula (II):

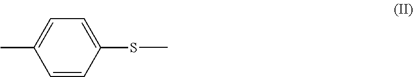

and segments having the structure of formula (III):

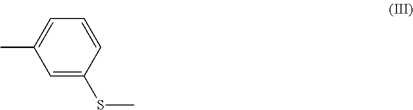

or segments having the structure of formula (IV):

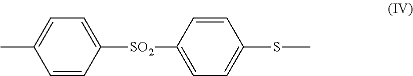

In general, the amount of the dihaloaromatic compound(s) per mole of the effective amount of the charged alkali metal sulfide can generally be from 1.0 to 2.0 moles, from 1.05 to 2.0 moles, or from 1.1 to 1.7 moles. Thus, the polyarylene sulfide can include alkyl halide (generally alkyl chloride) end groups.

A process for producing the polyarylene sulfide can include carrying out the polymerization reaction in an organic amide solvent. Exemplary organic amide solvents used in a polymerization reaction can include, without limitation, N-methyl-2-pyrrolidone; N-ethyl-2-pyrrolidone; N,N-dimethylformamide; N,N-dimethylacetamide; N-methylcaprolactam; tetramethylurea; dimethylimidazolidinone; hexamethyl phosphoric acid triamide and mixtures thereof. The amount of the organic amide solvent used in the reaction can be, e.g., from 0.2 to 5 kilograms per mole (kg/mol) of the effective amount of the alkali metal sulfide.

The polymerization can be carried out by a step-wise polymerization process. The first polymerization step can include introducing the dihaloaromatic compound to a reactor, and subjecting the dihaloaromatic compound to a polymerization reaction in the presence of water at a temperature of from about 180° C. to about 235° C., or from about 200° C. to about 230° C., and continuing polymerization until the conversion rate of the dihaloaromatic compound attains to not less than about 50 mol % of the theoretically necessary amount.

In a second polymerization step, water is added to the reaction slurry so that the total amount of water in the polymerization system is increased to about 7 moles, or to about 5 moles, per mole of the effective amount of the charged alkali metal sulfide. Following, the reaction mixture of the polymerization system can be heated to a temperature of from about 250° C. to about 290° C., from about 255° C. to about 280° C., or from about 260° C. to about 270° C. and the polymerization can continue until the melt viscosity of the thus formed polymer is raised to the desired final level of the polyarylene sulfide. The duration of the second polymerization step can be, e.g., from about 0.5 to about 20 hours, or from about 1 to about 10 hours.

The polyarylene sulfide may be linear, semi-linear, branched or crosslinked. A linear polyarylene sulfide includes as the main constituting unit the repeating unit of —(Ar—S)—. In general, a linear polyarylene sulfide may include about 80 mol % or more of this repeating unit. A linear polyarylene sulfide may include a small amount of a branching unit or a cross-linking unit, but the amount of branching or cross-linking units may be less than about 1 mol % of the total monomer units of the polyarylene sulfide. A linear polyarylene sulfide polymer may be a random copolymer or a block copolymer containing the above-mentioned repeating unit.

A semi-linear polyarylene sulfide may be utilized that may have a cross-linking structure or a branched structure provided by introducing into the polymer a small amount of one or more monomers having three or more reactive functional groups. For instance between about 1 mol % and about 10 mol % of the polymer may be formed from monomers having three or more reactive functional groups. Methods that may be used in making semi-linear polyarylene sulfide are generally known in the art. By way of example, monomer components used in forming a semi-linear polyarylene sulfide can include an amount of polyhaloaromatic compounds having 2 or more halogen substituents per molecule which can be utilized in preparing branched polymers. Such monomers can be represented by the formula R′Xₙ, where each X is selected from chlorine, bromine, and iodine, n is an integer of 3 to 6, and R′ is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′,4,4′-tetrachlorobiphenyl, 2,2′,5,5′-tetra-iodobiphenyl, 2,2′,6,6′-tetrabromo-3,3′,5,5′-tetramethylbiphenyl, 1,2,3,4-tetrachloronaphthalene, 1,2,4-tribromo-6-methylnaphthalene, and the like, and mixtures thereof.

Following polymerization, the polyarylene sulfide may be washed with liquid media. For instance, the polyarylene sulfide may be washed with water and/or organic solvents that will not decompose the polyarylene sulfide including, without limitation, acetone, N-methyl-2-pyrrolidone, a salt solution, and/or an acidic media such as acetic acid or hydrochloric acid prior to combination with other components while forming the mixture. The polyarylene sulfide can be washed in a sequential manner that is generally known to persons skilled in the art. Washing with an acidic solution or a salt solution may reduce the sodium, lithium or calcium metal ion end group concentration from about 2000 ppm to about 100 ppm.

A polyarylene sulfide can be subjected to a hot water washing process. The temperature of a hot water wash can be at or above about 100° C., for instance higher than about 120° C., higher than about 150° C., or higher than about 170° C.

The polymerization reaction apparatus for forming the polyarylene sulfide is not especially limited, although it is typically desired to employ an apparatus that is commonly used in formation of high viscosity fluids. Examples of such a reaction apparatus may include a stirring tank type polymerization reaction apparatus having a stirring device that has a variously shaped stirring blade, such as an anchor type, a multistage type, a spiral-ribbon type, a screw shaft type and the like, or a modified shape thereof. Further examples of such a reaction apparatus include a mixing apparatus commonly used in kneading, such as a kneader, a roll mill, a Banbury mixer, etc. Following polymerization, the molten polyarylene sulfide may be discharged from the reactor, typically through an extrusion orifice fitted with a die of desired configuration, cooled, and collected. Commonly, the polyarylene sulfide may be discharged through a perforated die to form strands that are taken up in a water bath, pelletized and dried. The polyarylene sulfide may also be in the form of a strand, granule, or powder.

The thermoplastic composition may include the polyarylene sulfide component (which also encompasses a blend of polyarylene sulfides) in an amount from about 10 wt. % to about 99 wt. % by weight of the composition, for instance from about 20% wt. % to about 90 wt. % by weight of the composition.

The polyarylene sulfide may be of any suitable molecular weight and melt viscosity, generally depending upon the final application intended for the thermoplastic composition. For instance, the melt viscosity of the polyarylene sulfide may be a low viscosity polyarylene sulfide, having a melt viscosity of less than about 500 poise, a medium viscosity polyarylene sulfide, having a melt viscosity of between about 500 poise and about 1500 poise, or a high melt viscosity polyarylene sulfide, having a melt viscosity of greater than about 1,500 poise, as determined in accordance with ISO Test No. 11443 at a shear rate of 1200 s⁻¹ and at a temperature of 310° C.

According to one embodiment, the polyarylene sulfide can be functionalized to further encourage bond formation between the polyarylene sulfide and the impact modifier. For instance, a polyarylene sulfide can be further treated following formation with a carboxyl, acid anhydride, amine, isocyanate or other functional group-containing modifying compound to provide a functional terminal group on the polyarylene sulfide. By way of example, a polyarylene sulfide can be reacted with a modifying compound containing a mercapto group or a disulfide group and also containing a reactive functional group. In one embodiment, the polyarylene sulfide can be reacted with the modifying compound in an organic solvent. In another embodiment, the polyarylene sulfide can be reacted with the modifying compound in the molten state.

In one embodiment, a disulfide compound containing the desired functional group can be incorporated into the thermoplastic composition formation process, and the polyarylene sulfide can be functionalized in conjunction with formation of the composition. For instance, a disulfide compound containing the desired reactive functional groups can be added to the melt extruder in conjunction with the polyarylene sulfide or at any other point prior to or in conjunction with the addition of the crosslinking agent.

Reaction between the polyarylene sulfide polymer and the reactively functionalized disulfide compound can include chain scission of the polyarylene sulfide polymer that can decrease melt viscosity of the polyarylene sulfide. In one embodiment, a higher melt viscosity polyarylene sulfide having low halogen content can be utilized as a starting polymer. Following reactive functionalization of the polyarylene sulfide polymer by use of a functional disulfide compound, a relatively low melt viscosity polyarylene sulfide with low halogen content can be formed. Following this chain scission, the melt viscosity of the polyarylene sulfide can be suitable for further processing, and the overall halogen content of the low melt viscosity polyarylene sulfide can be quite low. A thermoplastic composition that exhibits excellent strength and degradation resistance in addition to low halogen content can be advantageous as low halogen content polymeric materials are becoming increasingly desired due to environmental concerns. In one embodiment, the thermoplastic composition can have a halogen content of less than about 1000 ppm, less than about 900 ppm, less than about 600 ppm, or less than about 400 ppm as determined according to an elemental analysis using Parr Bomb combustion followed by Ion Chromatography.

The disulfide compound can generally have the structure of:

R¹—S—S—R²

wherein R¹ and R² may be the same or different and are hydrocarbon groups that independently include from 1 to about 20 carbons. For instance, R¹ and R² may be an alkyl, cycloalkyl, aryl, or heterocyclic group. R¹ and R¹ may include reactive functionality at terminal end(s) of the disulfide compound. For example, at least one of R¹ and R² may include a terminal carboxyl group, hydroxyl group, a substituted or non-substituted amino group, a nitro group, or the like. In general, the reactive functionality can be selected such that the reactively functionalized polyarylene sulfide can react with the impact modifier. For example, when considering an epoxy-terminated impact modifier, the disulfide compound can include carboxyl and/or amine functionality.

Examples of disulfide compounds including reactive terminal groups as may be encompassed herein may include, without limitation, 2,2′-diaminodiphenyl disulfide, 3,3′-diaminodiphenyl disulfide, 4,4′-diaminodiphenyl disulfide, dibenzyl disulfide, dithiosalicyclic acid, dithioglycolic acid, α,α′-dithiodilactic acid, β,β′-dithiodilactic acid, 3,3′-dithiodipyridine, 4,4′dithiomorpholine, 2,2′-dithiobis(benzothiazole), 2,2′-dithiobis(benzimidazole), 2,2′-dithiobis(benzoxazole) and 2-(4′-morpholinodithio)benzothiazole.

The ratio of the amount of the polyarylene sulfide to the amount of the disulfide compound can be from about 1000:1 to about 10:1, from about 500:1 to about 20:1, or from about 400:1 to about 30:1.

In addition to the polyarylene sulfide polymer and the carbon nanotubes, the composition also includes an impact modifier. More specifically, the impact modifier can be an olefinic copolymer or terpolymer. For instance, the impact modifier can include ethylenically unsaturated monomer units have from about 4 to about 10 carbon atoms.

The impact modifier can be modified to include functionalization so as to react with the crosslinking agent. For instance, the impact modifier can be modified with a mole fraction of from about 0.01 to about 0.5 of one or more of the following: an α,β unsaturated dicarboxylic acid or salt thereof having from about 3 to about 8 carbon atoms; an α,β unsaturated carboxylic acid or salt thereof having from about 3 to about 8 carbon atoms; an anhydride or salt thereof having from about 3 to about 8 carbon atoms; a monoester or salt thereof having from about 3 to about 8 carbon atoms; a sulfonic acid or a salt thereof; an unsaturated epoxy compound having from about 4 to about 11 carbon atoms. Examples of such modification functionalities include maleic anhydride, fumaric acid, maleic acid, methacrylic acid, acrylic acid, and glycidyl methacrylate. Examples of metallic acid salts include the alkaline metal and transitional metal salts such as sodium, zinc, and aluminum salts.

A non-limiting listing of impact modifiers that may be used include ethylene-acrylic acid copolymer, ethylene-maleic anhydride copolymers, ethylene-alkyl (meth)acrylate-maleic anhydride terpolymers, ethylene-alkyl (meth)acrylate-glycidyl (meth)acrylate terpolymers, ethylene-acrylic ester-methacrylic acid terpolymer, ethylene-acrylic ester-maleic anhydride terpolymer, ethylene-methacrylic acid-methacrylic acid alkaline metal salt (ionomer) terpolymers, and the like. In one embodiment, for instance, an impact modifier can include a random terpolymer of ethylene, methylacrylate, and glycidyl methacrylate. The terpolymer can have a glycidyl methacrylate content of from about 5% to about 20%, such as from about 6% to about 10%. The terpolymer may have a methylacrylate content of from about 20% to about 30%, such as about 24%.

According to one embodiment, the impact modifier may be a linear or branched, homopolymer or copolymer (e.g., random, graft, block, etc.) containing epoxy functionalization, e.g., terminal epoxy groups, skeletal oxirane units, and/or pendent epoxy groups. For instance, the impact modifier may be a copolymer including at least one monomer component that includes epoxy functionalization. The monomer units of the impact modifier may vary. In one embodiment, for example, the impact modifier can include epoxy-functional methacrylic monomer units. As used herein, the term methacrylic generally refers to both acrylic and methacrylic monomers, as well as salts and esters thereof, e.g., acrylate and methacrylate monomers. Epoxy-functional methacrylic monomers as may be incorporated in the impact modifier may include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate.

Other monomer units may additionally or alternatively be a component of the impact modifier. Examples of other monomers may include, for example, ester monomers, olefin monomers, amide monomers, etc. In one embodiment, the impact modifier can include at least one linear or branched a-olefin monomer, such as those having from 2 to 20 carbon atoms, or from 2 to 8 carbon atoms. Specific examples include ethylene; propylene; 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents: 1-octene with one or more methyl, ethyl or propyl substituents; 1-nonene with one or more methyl, ethyl or propyl substituents; ethyl, methyl or dimethyl-substituted 1-decene; 1-dodecene; and styrene.

Monomers included in an impact modifier that includes epoxy functionalization can include monomers that do not include epoxy functionalization, as long as at least a portion of the monomer units of the polymer are epoxy functionalized.

In one embodiment, the impact modifier can be a terpolymer that includes epoxy functionalization. For instance, the impact modifier can include a methacrylic component that includes epoxy functionalization, an α-olefin component, and a methacrylic component that does not include epoxy functionalization. For example, the impact modifier may be poly(ethylene-co-methylacrylate-co-glycidyl methacrylate), which has the following structure:

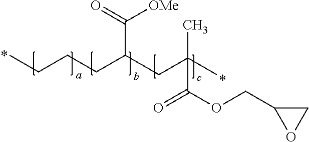

wherein, a, b, and c are 1 or greater.

In another embodiment the impact modifier can be a random copolymer of ethylene, ethyl acrylate and maleic anhydride having the following structure:

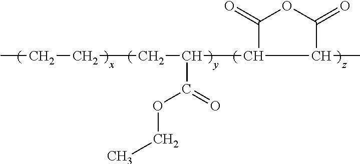

wherein x, y and z are 1 or greater.

The relative proportion of the various monomer components of a copolymeric impact modifier is not particularly limited. For instance, in one embodiment, the epoxy-functional methacrylic monomer components can form from about 1 wt. % to about 25 wt. %, or from about 2 wt. % to about 20 wt % of a copolymeric impact modifier. An a-olefin monomer can form from about 55 wt. % to about 95 wt. %, or from about 60 wt. % to about 90 wt. %, of a copolymeric impact modifier. When employed, other monomeric components (e.g., a non-epoxy functional methacrylic monomers) may constitute from about 5 wt. % to about 35 wt. %, or from about 8 wt. % to about 30 wt. %, of a copolymeric impact modifier.

An impact modifier may be formed according to standard polymerization methods as are generally known in the art. For example, a monomer containing polar functional groups may be grafted onto a polymer backbone to form a graft copolymer. Alternatively, a monomer containing functional groups may be copolymerized with a monomer to form a block or random copolymer using known free radical polymerization techniques, such as high pressure reactions, Ziegler-Natta catalyst reaction systems, single site catalyst (e.g., metallocene) reaction systems, etc.

Alternatively, an impact modifier may be obtained on the retail market. By way of example, suitable compounds for use as an impact modifier may be obtained from Arkema under the name Lotader®.

The molecular weight of the impact modifier can vary widely. For example, the impact modifier can have a number average molecular weight from about 7,500 to about 250,000 grams per mole, in some embodiments from about 15,000 to about 150,000 grams per mole, and in some embodiments, from about 20,000 to 100,000 grams per mole, with a polydispersity index typically ranging from 2.5 to 7.

In general, the impact modifier may be present in the composition in an amount from about 0.05% to about 40% by weight, from about 0.05% to about 37% by weight, or from about 0.1% to about 35% by weight.

Referring again to FIG. 1, the impact modifier can be added to the composition in conjunction with the polyarylene sulfide at the main feed throat 14 of the melt processing unit. This is not a requirement of the composition formation process, however, and in other embodiments, the impact modifier can be added downstream of the main feed throat. For instance, the impact modifier may be added at a location downstream from the point at which the polyarylene sulfide is supplied to the melt processing unit, but yet prior to the melting section, i.e., that length of the melt processing unit in which the polyarylene sulfide becomes molten. In another embodiment, the impact modifier may be added at a location downstream from the point at which the polyarylene sulfide becomes molten. In one embodiment, the impact modifier can be added downstream of the main feed throat and in conjunction with the carbon nanotubes.

If desired, one or more distributive and/or dispersive mixing elements may be employed within the mixing section of the melt processing unit. Suitable distributive mixers for single screw extruders may include but are not limited to, for instance, Saxon, Dulmage, Cavity Transfer mixers, etc. Likewise, suitable dispersive mixers may include but are not limited to Blister ring, Leroy/Maddock, CRD mixers, etc. As is well known in the art, the mixing may be further improved by using pins in the barrel that create a folding and reorientation of the polymer melt, such as those used in Buss Kneader extruders, Cavity Transfer mixers, and Vortex Intermeshing Pin mixers.

In addition to the polyarylene sulfide, the carbon nanotubes, and the impact modifier, the polyarylene composition can include a crosslinking agent. The crosslinking agent can be a polyfunctional compound or combination thereof that can react with functionality of the impact modifier to form crosslinks within and among the polymer chains of the impact modifier. In general, the crosslinking agent can be a non-polymeric compound, i.e., a molecular compound that includes two or more reactively functional terminal moieties linked by a bond or a non-polymeric (non-repeating) linking component. By way of example, the crosslinking agent can include but is not limited to di-epoxides, poly-functional epoxides, diisocyanates, polyisocyanates, polyhydric alcohols, water-soluble carbodiimides, diamines, diaminoalkanes, polyfunctional carboxylic acids, diacid halides, and so forth. For instance, when considering an epoxy-functional impact modifier, a non-polymeric polyfunctional carboxylic acid or amine can be utilized as a crosslinking agent.

Specific examples of polyfunctional carboxylic acid crosslinking agents can include, without limitation, isophthalic acid, terephthalic acid, phthalic acid, 1,2-di(p-carboxyphenyl)ethane, 4,4′-dicarboxydiphenyl ether, 4,4′-bisbenzoic acid, 1,4- or 1,5-naphthalene dicarboxylic acids, decahydronaphthalene dicarboxylic acids, norbornene dicarboxylic acids, bicyclooctane dicarboxylic acids, 1,4-cyclohexanedicarboxylic acid (both cis and trans), 1,4-hexylenedicarboxylic acid, adipic acid, azelaic acid, dicarboxyl dodecanoic acid, succinic acid, maleic acid, glutaric acid, suberic acid, azelaic acid and sebacic acid. The corresponding dicarboxylic acid derivatives, such as carboxylic acid diesters having from 1 to 4 carbon atoms in the alcohol radical, carboxylic acid anhydrides or carboxylic acid halides may also be utilized.

Exemplary diols useful as crosslinking agents can include, without limitation, aliphatic diols such as ethylene glycol, 1,2-propylene glycol, 1,3-propylene glycol, 2,2-dimethyl-1,3-propane diol, 2-ethyl-2-methyl-1,3-propane diol, 1,4-butane diol, 1,4-but-2-ene diol, 1,3-1,5-pentane diol, 1,5-pentane diol, dipropylene glycol, 2-methyl-1,5-pentane diol, and the like. Aromatic diols can also be utilized such as, without limitation, hydroquinone, catechol, resorcinol, methylhydroquinone, chlorohydroquinone, bisphenol A, tetrachlorobisphenol A, phenolphthalein, and the like. Exemplary cycloaliphatic diols as may be used include a cycloaliphatic moiety, for example 1,6-hexane diol, dimethanol decalin, dimethanol bicyclooctane, 1,4-cyclohexane dimethanol (including its cis- and trans-isomers), triethylene glycol, 1,10-decanediol, and the like.

Exemplary diamines that may be utilized as crosslinking agents can include, without limitation, isophorone-diamine, ethylenediamine, 1,2-, 1,3-propylene-diamine, N-methyl-1,3-propylene-diamine, N,N′-dimethyl-ethylene-diamine, and aromatic diamines, such as, for example, 2,4- and 2,6-toluoylene-diamine, 3,5-diethyl-2,4- and/or -2,6-toluoylene-diamine, and primary ortho- di-, tri- and/or tetra-alkyl-substituted 4,4′-diaminodiphenyl-methanes, (cyclo)aliphatic diamines, such as, for example, isophorone-diamine, ethylenediamine, 1,2-, 1,3-propylene-diamine, N-methyl-1,3-propylene-diamine, N,N′-dimethyl-ethylene-diamine, and aromatic diamines, such as, for example, 2,4- and 2,6-toluoylene-diamine, 3,5-diethyl-2,4- and/or -2,6-toluoylene-diamine, and primary ortho- di-, tri- and/or tetra-alkyl-substituted 4,4′-diaminodiphenyl-methanes.

In one embodiment, the composition can include a disulfide-free crosslinking agent. For example, the crosslinking agent can include carboxyl and/or amine functionality with no disulfide group that may react with the polyarylene sulfide. A crosslinking agent that is disulfide-free can be utilized so as to avoid excessive chain scission of the polyarylene sulfide by the crosslinking agent during formation of the composition. It should be understood, however, that the utilization of a disulfide-free crosslinking agent does not in any way limit the utilization of a reactively functionalized disulfide compound for functionalizing the polyarylene sulfide. For instance, in one embodiment, the composition can be formed according to a process that includes addition of a reactively functionalized disulfide compound to the melt processing unit that can reactively functionalize the polyarylene sulfide. The crosslinking agent utilized in this embodiment can then be a disulfide-free crosslinking agent that can include functionality that is reactive with the impact modifier as well as with the reactively functionalized polyarylene sulfide. Thus, the composition can be highly crosslinked without excessive scission of the polyarylene sulfide polymer chains.

In another embodiment both the crosslinking agent and the polyarylene sulfide functionalization compound (when present) can be selected so as to encourage chain scission of the polyarylene sulfide. This may be beneficial, for instance, which chain scission is desired to decrease the melt viscosity of the polyarylene sulfide polymer.

The thermoplastic composition may generally include the crosslinking agent in an amount from about 0.05 wt. % to about 2 wt. % by weight of the thermoplastic composition, from about 0.07 wt. % to about 1.5 wt. % by weight of the thermoplastic composition, or from about 0.1 wt. % to about 1.3 wt. %.

The crosslinking agent can be added to the melt processing unit following mixing of the polyarylene sulfide and the impact modifier. For instance, as illustrated in FIG. 1, the crosslinking agent can be added to the composition at a downstream location 16 following addition of polyarylene sulfide, the carbon nanotubes, and the impact modifier (either together or separately) to the melt processing unit. This can ensure that the impact modifier and the carbon nanotubes have become dispersed throughout the polyarylene sulfide prior to addition of the crosslinking agent.

To help encourage distribution of the impact modifier and the carbon nanotubes throughout the melt prior to addition of the crosslinking agent, a variety of different parameters may be selectively controlled. For example, the ratio of the length (“L”) to diameter (“D”) of a screw of the melt processing unit may be selected to achieve an optimum balance between throughput and additive distribution. For example, the L/D value after the point at which the impact modifier is supplied may be controlled to encourage distribution of the impact modifier. More particularly, the screw has a blending length (“L_{B}”) that is defined from the point at which all of the impact modifier, the carbon nanotubes, and the polyarylene sulfide are supplied to the unit (i.e., either where they are all supplied in conjunction with one another or the point at which the last of the three is supplied) to the point at which the crosslinking agent is supplied, the blending length generally being less than the total length of the screw. For example, when considering a melt processing unit that has an overall L/D of 40, the L_{B}/D ratio of the screw can be from about 1 to about 36, in some embodiments from about 4 to about 20, and in some embodiments, from about 5 to about 15. In one embodiment, the L/La ratio can be from about 40 to about 1.1, from about 20 to about 2, or from about 10 to about 5.

Following addition of the crosslinking agent, the composition can be mixed to distribute the crosslinking agent throughout the composition and encourage reaction between the crosslinking agent, the impact modifier, and, in one embodiment, with the polyarylene sulfide.

The composition can also include one or more additives as are generally known in the art. For example, one or more fillers can be included in the thermoplastic composition. One or more fillers may generally be included in the thermoplastic composition an amount of from about 5 wt. % to about 70 wt. %, or from about 20 wt. % to about 65 wt. % by weight of the thermoplastic composition.

The filler can be added to the thermoplastic composition according to standard practice. For instance, the filler can be added to the composition at a downstream location of the melt processing unit. For example, a filler may be added to the composition in conjunction with the addition of the crosslinking agent. However, this is not a requirement of a formation process and the filler can be added separately from the crosslinking agent and either upstream or downstream of the point of addition of the crosslinking agent. In addition, a filler can be added at a single feed location, or may be split and added at multiple feed locations along the melt processing unit.

In one embodiment, a fibrous filler can be included in the thermoplastic composition. The fibrous filler may include one or more fiber types including, without limitation, polymer fibers, glass fibers, carbon fibers, metal fibers, basalt fibers, and so forth, or a combination of fiber types. In one embodiment, the fibers may be chopped fibers, continuous fibers, or fiber rovings (tows).

Fiber sizes can vary as is known in the art. In one embodiment, the fibers can have an initial length of from about 3 mm to about 5 mm. In another embodiment, for instance when considering a pultrusion process, the fibers can be continuous fibers. Fiber diameters can vary depending upon the particular fiber used. The fibers, for instance, can have a diameter of less than about 100 μm, such as less than about 50 μm. For instance, the fibers can be chopped or continuous fibers and can have a fiber diameter of from about 5 μm to about 50 μm, such as from about 5 μm to about 15 μm.

The fibers may be pretreated with a sizing as is generally known. In one embodiment, the fibers may have a high yield or small K numbers. The tow is indicated by the yield or K number. For instance, glass fiber tows may have 50 yield and up, for instance from about 115 yield to about 1200 yield.

Other fillers can alternatively be utilized or may be utilized in conjunction with a fibrous filler. For instance, a particulate filler can be incorporated in the thermoplastic composition. In general, particulate fillers can encompass any particulate material having a median particle size of less than about 750 μm, for instance less than about 500 μm, or less than about 100 μm. In one embodiment, a particulate filler can have a median particle size in the range of from about 3 μm to about 20 μm. In addition, a particulate filler can be solid or hollow, as is known. Particulate fillers can also include a surface treatment, as is known in the art.

Particulate fillers can encompass one or more mineral fillers. For instance, the thermoplastic composition can include one or more mineral fillers in an amount of from about 1 wt. % to about 60 wt. % of the composition. Mineral fillers may include, without limitation, silica, quartz powder, silicates such as calcium silicate, aluminum silicate, kaolin, talc, mica, clay, diatomaceous earth, wollastonite, calcium carbonate, and so forth.

When incorporating multiple fillers, for instance a particulate filler and a fibrous filler, the fillers may be added together or separately to the melt processing unit. For instance, a particulate filler can be added to the main feed with the polyarylene sulfide or downstream prior to addition of a fibrous filler, and a fibrous filler can be added further downstream of the addition point of the particulate filler. In general, a fibrous filler can be added downstream of any other fillers such as a particulate filler, though this is not a requirement.

A filler can be an additional electrically conductive filler such as, without limitation, carbon black, graphite, graphene, carbon fiber, a metal powder, and so forth. In those embodiments in which the thermoplastic composition includes an additional electrically conductive filler, in addition to the carbon nanotubes, the total electrical conductive loading level can generally be about 20% by weight of the thermoplastic composition or less.

In one embodiment, the thermoplastic composition can include a UV stabilizer as an additive. For instance, the thermoplastic composition can include a UV stabilizer in an amount of between about 0.5 wt. % and about 15 wt. %, between about 1 wt. % and about 8 wt. %, or between about 1.5 wt. % and about 7 wt. % of a UV stabilizer. One particularly suitable UV stabilizer that may be employed is a hindered amine UV stabilizer. Suitable hindered amine UV stabilizer compounds may be derived from a substituted piperidine, such as alkyl-substituted piperidyl, piperidinyl, piperazinone, alkoxypiperidinyl compounds, and so forth. For example, the hindered amine may be derived from a 2,2,6,6-tetraalkylpiperidinyl. The hindered amine may, for example, be an oligomeric or polymeric compound having a number average molecular weight of about 1,000 or more, in some embodiments from about 1000 to about 20,000, in some embodiments from about 1500 to about 15,000, and in some embodiments, from about 2000 to about 5000. Such compounds typically contain at least one 2,2,6,6-tetraalkylpiperidinyl group (e.g., 1 to 4) per polymer repeating unit. One particularly suitable high molecular weight hindered amine is commercially available from Clariant under the designation Hostavin® N30 (number average molecular weight of 1200). Another suitable high molecular weight hindered amine is commercially available from Adeka Palmarole SAS under the designation ADK STAB® LA-63 and ADK STAB® LA-68.

In addition to the high molecular hindered amines, low molecular weight hindered amines may also be employed. Such hindered amines are generally monomeric in nature and have a molecular weight of about 1000 or less, in some embodiments from about 155 to about 800, and in some embodiments, from about 300 to about 800.

Other suitable UV stabilizers may include UV absorbers, such as benzotriazoles or benzopheones, which can absorb UV radiation.

An additive that may be included in a thermoplastic composition is one or more colorants as are generally known in the art. For instance, the thermoplastic composition can include from about 0.1 wt. % to about 10 wt. %, or from about 0.2 wt. % to about 5 wt. % of one or more colorants. As utilized herein, the term “colorant” generally refers to any substance that can impart color to a material. Thus, the term “colorant” encompasses both dyes, which exhibit solubility in an aqueous solution, and pigments, that exhibit little or no solubility in an aqueous solution.

Examples of dyes that may be used include, but are not limited to, disperse dyes. Suitable disperse dyes may include those described in “Disperse Dyes” in the Color Index, 3^{rd} edition. Such dyes include, for example, carboxylic acid group-free and/or sulfonic acid group-free nitro, amino, aminoketone, ketoninime, methine, polymethine, diphenylamine, quinoline, benzimidazole, xanthene, oxazine and coumarin dyes, anthraquinone and azo dyes, such as mono- or di-azo dyes. Disperse dyes also include primary red color disperse dyes, primary blue color disperse dyes, and primary yellow color dyes.

Pigments that can be incorporated in a thermoplastic composition can include, without limitation, organic pigments, inorganic pigments, metallic pigments, phosphorescent pigments, fluorescent pigments, photochromic pigments, thermochromic pigments, iridescent pigments, and pearlescent pigments. The specific amount of pigment can depends upon the desired final color of the product. Pastel colors are generally achieved with the addition of titanium dioxide white or a similar white pigment to a colored pigment.

Other additives that can be included in the thermoplastic composition can encompass, without limitation, antimicrobials, lubricants, pigments or other colorants, impact modifiers, antioxidants, stabilizers (e.g., heat stabilizers including organophosphites such as Doverphos® products available from Dover Chemical Corporation), surfactants, flow promoters, solid solvents, and other materials added to enhance properties and processability. Such optional materials may be employed in the thermoplastic composition in conventional amounts and according to conventional processing techniques, for instance through addition to the thermoplastic composition at the main feed throat. Beneficially, the thermoplastic composition can exhibit desirable characteristics without the addition of plasticizers. For instance, the composition can be free of plasticizers such as phthalate esters, trimellitates, sebacates, adipates, gluterates, azelates, maleates, benzoates, and so forth.

Following addition of all components to the thermoplastic composition, the composition is thoroughly mixed in the remaining section(s) of the extruder and extruded through a die. The final extrudate can be pelletized or otherwise shaped as desired, for instance the final extrudate can be in the form of a pultruded tape or ribbon.

Conventional shaping processes can be used for forming the tubular members out of the thermoplastic composition including, without limitation, extrusion, injection molding, blow-molding, thermoforming, foaming, compression molding, hot-stamping, and so forth. Tubular members that may be formed may include structural and non-structural members, for instance components for automotive engineering thermoplastic assemblies as well as industrial applications such as components of cooling tower pumps, water heaters, and the like. For instance thermoform sheets, foamed substrates, injection molded or blow molded components, and the like can be formed from the thermoplastic composition.

Tubular members as may be utilized for carrying liquids or gases, and in one particular embodiment heated liquids or gases, may be formed from the thermoplastic composition. For instance tubular members including hoses, pipes, conduits and the like can be formed from the thermoplastic composition. The tubular members may be single-layered or multi-layered. Typical conventional extrusion or molding processes may be used for forming the tubular members. For instance, either single or multi-screw extruders may be used for extrusion of the tubing. In another embodiment, a blow molding process may be utilized in forming a tubular hollow member.

Referring to FIG. 2, one embodiment of a tubular member 110 formed from the thermoplastic composition is shown. As shown, the tubular member 110 extends in multiple directions leading to a relatively complex shape. For instance, before the thermoplastic composition can solidify, the angular displacements as shown in FIG. 2 can be formed into the part. The tubular member 110 includes angular displacement changes at 112, 114 and 116. The tubular member 110 may comprise, for instance, a part that may be used in the exhaust system of a vehicle.

A tubular member can include the thermoplastic composition throughout the entire member or only a portion of the member. For instance, the tubular member can be formed such that the thermoplastic composition extends along a section of the member and an adjacent section can be formed of a different composition, for instance a different thermoplastic composition. Such a tubular member can be formed by, e.g., altering the material that is fed to a molding device during a formation process. The tubular member can include an area in which the two materials are mixed that represents a border region between a first section and a second section formed of different materials. A tubular member can include a single section formed of the thermoplastic composition or a plurality of sections, as desired. Moreover, other sections of a member can be formed of multiple different materials. By way of example, when considering a tubular member intended to function as a fluid conduit, both ends of the tubular member can be formed of the thermoplastic composition and a center section can be formed of a less flexible composition. Thus, the more flexible ends can be utilized to tightly affix the tubular member to other components of a system. Alternatively, a center section of a tubular member could be formed from the thermoplastic composition, which can improve flexibility of the member in that section, making installation of the tubular member easier and/or allowing for flexibility during use.

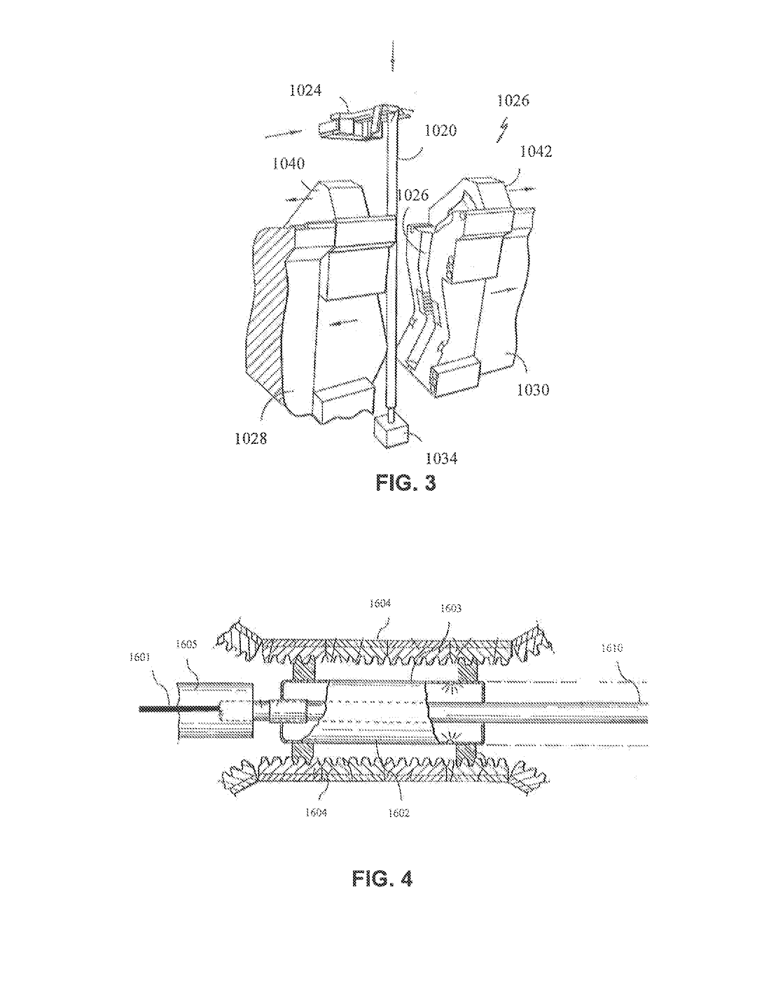

According to one embodiment, the tubular member such as the tubular member 110 illustrated in FIG. 2 can be a single layer tubular member formed according to a blow molding process. FIG. 3 illustrates one method as may be utilized for forming a tubular member from the thermoplastic composition.

During blow molding, the thermoplastic composition is first heated and extruded into a parison 1020 using a die attached to an extrusion device. When the parison 1020 is formed, the composition must have sufficient melt strength to prevent gravity from undesirably elongating portions of the parison 1020 and thereby forming non-uniform wall thicknesses and other imperfections. The parison is received into a molding device 1026, generally formed of multiple sections 1028, 1030, 1040, 1042 that together form a three-dimensional mold cavity 1026. For instance, a robotic arm 1024 can be utilized to manipulate the parison 1020 in the molding device.

As can be appreciated, a certain period of time elapses from formation of the parison 1020 to moving the parison into engagement with the molding device. During this stage of the process, the melt strength of the thermoplastic composition can be high enough such that the parison 1020 maintains its shape during movement. The thermoplastic composition can also be capable of remaining in a semi-fluid state and not solidifying too rapidly before blow molding commences.

Once the molding device is closed, a gas, such as an inert gas is fed into the parison 1020 from a gas supply 1034. The gas supplies sufficient pressure against the interior surface of the parison such that the parison conforms to the shape of the mold cavity. After blow molding, the sections can be opened as indicated by the directional arrows, and the finished shaped article is then removed. In one embodiment, cool air can be injected into the molded part for solidifying the thermoplastic composition prior to removal from the molding device.

According to another embodiment illustrated in FIG. 4, a continuous blow molding process can be used to form a tubular member as may be useful in piping applications. FIG. 4 presents a schematic illustration of one method as may be utilized in forming a long tubular component according to a continuous blow molding process. In a continuous process, a stationary extruder (not shown) can plasticize and force the molten thermoplastic composition through a head to form a continuous parison 1601. An accumulator 1605 can be used to support the parison 1601 and prevent sagging prior to molding. The parison may be fed to a mold formed of articulated sections 1602, 1603 that travel in conjunction with the continuous parison on a mold conveyor assembly 1604. Air under pressure is applied to the parison to blow mold the composition within the mold. After the composition has been molded and sufficiently cooled within the mold as the mold and composition travel together, the mold segments are separated from one another and the formed section of the component (e.g., the pipe) 1606 is removed from the conveyor and taken up, as on a take-up reel (not shown).

A tubular member such as a pipe or a tube can be formed according to an extrusion process. For example, an extrusion process utilizing a simple or barrier type screw can be utilized and, in one embodiment, a mixing tip need not be utilized in the process. The compression ratio for an extrusion process can be between about 2.5:1 and about 4:1. For instance, the compression ratio can be about 25% feed, about 25% transition, and about 50% metering. The ratio of the barrel length to the barrel diameter (L/D) can be from about 16 to about 24. An extrusion process can also utilize other standard components as are known in the art such as, for example, breaker plates, screen packs, adapters, a die, and a vacuum tank. The vacuum tank can generally include a sizing sleeve/calibration ring, tank seals, and the like.

When forming a tubular member according to an extrusion process, the thermoplastic composition can first be dried, for instance at a temperature of from about 90° C. to about 100° C. for about three hours. It may be beneficial to avoid drying for an extensive length of time so as to avoid discoloration of the composition. The extruder can exhibit different temperatures in different zones, as is known. For instance, in one embodiment, the extruder can include at least four zones, with the temperature of the first zone from about 276° C. to about 288° C., the temperature of the second zone from about 282° C. to about 299° C., the temperature of the third zone from about 282° C. to about 299° C., and the temperature of the fourth zone from about 282° C. to about 304° C. Meanwhile, the temperature of the die can be from about 293° C. to about 310° C., and the vacuum tank water can be from about 20° C. to about 50° C.

Typically, the head pressure can be from about 100 pounds per square inch (psi) (about 690 kPa) to about 1000 psi (about 6900 kPa), and the head pressure can be adjusted to achieve a stable melt flow, as is known. For instance, the head pressure can be reduced by increasing the extruder zone temperature, by increasing the extruder screw rotations per minute, reducing the screen pack mesh size and/or the number of screens, and so forth. In general, the line speed can be from about 4 meters per minute to about 15 meters per minute. Of course, the actual line speed can depend upon the final dimension of the final product, the aesthetics of the final product and process stability.

The die swell during an extrusion process can generally be negligible. A draw down of about 1.2 to about 1.7 can generally be utilized, as a higher draw down can negatively affect the final properties of the product, depending on other processing conditions. Die drool can generally be avoided by drying the resin adequately prior to extrusion as well as by maintaining the melt temperature at less than about 304° C.

In one embodiment, tubular members extruded from the thermoplastic composition can have a wall thickness of between about 0.5 millimeters to about 5 millimeters, though tubular members having larger wall thickness can be formed from the composition as desired. The calibration ring inner diameter can decide the outer diameter of the tubular member and will generally be less than the outer diameter of the die, as is known. The inner diameter of the tubular member can be utilized to determine the desired outer diameter of the mandrel and the line speed, as is known.

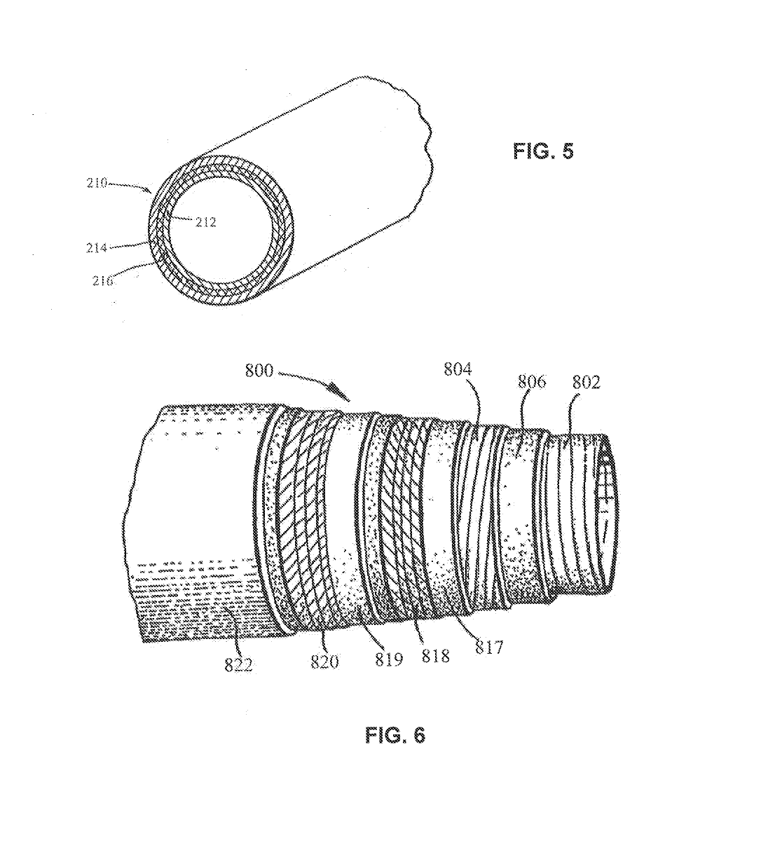

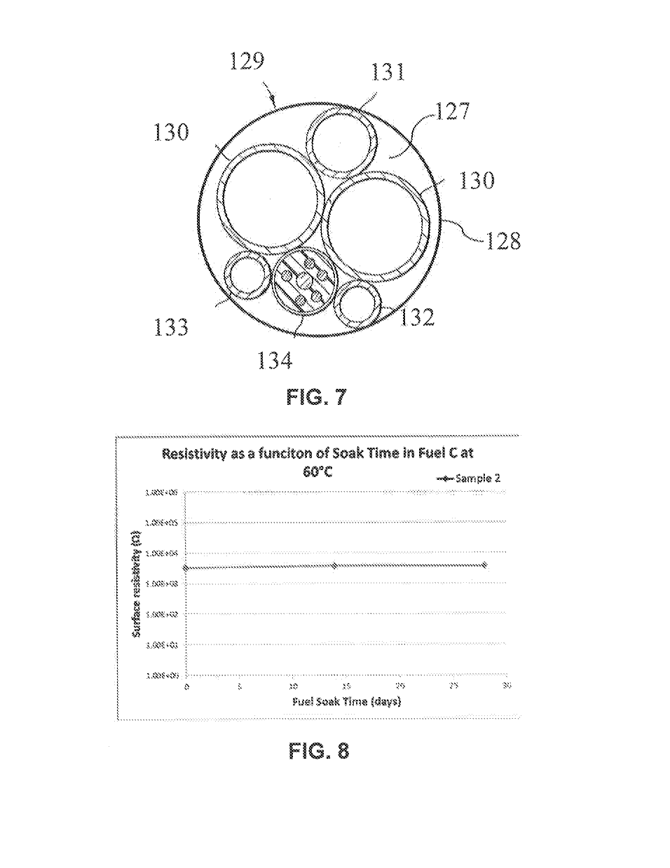

A tubular member that incorporates the thermoplastic composition can be a multi-layered tubular member. FIG. 5 illustrates a multi-layered tubular member 210 as may incorporate the thermoplastic composition in one or more layers of the tubular member. For example, at least the inner layer 212 can include the thermoplastic composition that exhibits conductivity, low permeability, high impact strength characteristics under a wide temperature range and which is substantially inert to the materials to be carried within the tubular member 210.

The outer layer 214 and the intermediate layer 216 can include a thermoplastic composition that is the same or different than the thermoplastic composition described herein. Alternatively, other layers of the multilayer tubular member may be formed of different materials. For example, in one embodiment the intermediate layer 216 can exhibit high resistance to pressure and mechanical effects. By way of example, layer 216 can be formed of polyamides from the group of homopolyamides, co-polyamides, their blends or mixtures which each other or with other polymers. Alternatively, layer 216 can be formed of a fiber reinforced material such as a fiber-reinforced resin composite or the like. For example, a polyaramid (e.g., Kevlar®) woven mat can be utilized to form an intermediate layer 216 that is highly resistant to mechanical assaults. An intermediate later can be included such as a spiraled, knitted or braided layer of textile or wire. In a spiral construction, for example, the spiraled layer may comprise two layers, each applied at or near the so-called lock angle or neutral angle of about 54° with respect to the longitudinal axis of the tubular member 210 but with opposite spiral directions. However, the tubular member 210 is not limited to spiral constructions. An intermediate layer 216 may be a knit, braided, wrapped, woven, or non-woven fabric.

Outer layer 214 can provide protection from external assaults as well as provide insulative or other desirable characteristics to the tubular member. For example, a multi-layer hose can include an outer layer 214 formed from an adequate kind of rubber material having high levels of chipping, weather, flame and cold resistance. Examples of such materials include thermoplastic elastomer such as polyamide thermoplastic elastomer, polyester thermoplastic elastomer, polyolefin thermoplastic elastomer, and styrene thermoplastic elastomer. Suitable materials for outer layer 214 include, without limitation, ethylene-propylene-diene terpolymer rubber, ethylene-propylene rubber, chlorosulfonated polyethylene rubber, a blend of acrylonitrile-butadiene rubber and polyvinyl chloride, a blend of acrylonitrile-butadiene rubber and ethylene-propylene-diene terpolymer rubber, and chlorinated polyethylene rubber.

Outer layer 214 can alternatively be formed of a harder, less flexible material, such as a polyolefin, polyvinylchloride, or a high density polyethylene, a fiber reinforced composite material such as a glass fiber composite or a carbon fiber composite, or a metal material such as a steel jacket.

Of course, a multi-layer tubular member is not limited to three layers, and may include two, four, or more distinct layers. A multi-layer tubular member may further contain one or more adhesive layers formed from adhesive materials such as, for example, polyester polyurethanes, polyether polyurethanes, polyester elastomers, polyether elastomers, polyamides, polyether polyamides, polyether polyimides, functionalized polyolefins, and the like.

Multilayer tubular members may be made by conventional processes, such as, for example, co-extrusion, dry lamination, sandwich lamination, coextrusion coating, blow molding, continuous blow molding, and the like. By way of example, in forming a three-layered tubular member 210 as illustrated in FIG. 5, the thermoplastic composition, a polyamide composition, and a thermoplastic elastomer composition can be separately fed into three different extruders. The separate extrusion melts from those three extruders can then be introduced into one die under pressure. While producing three different tubular melt flows, those melt flows can be combined in the die in such a manner that the melt flow of the thermoplastic composition forms the inner layer 212, that of the polyamide composition forms the intermediate layer 216, and that of the thermoplastic elastomer composition forms the outer layer 214, and the thus-combined melt flows are co-extruded out of the die to produce a three-layered tubular member.

Of course, any known tube-forming methods including blow molding methods as described above is employable. For instance, in one embodiment, one or more layers of the multi-layered tubular member can be formed from a continuous tape, e.g., a fiber reinforced tape or ribbon formed according to a pultrusion formation method. A tape can be wrapped to form the tubular member or a layer of a multilayered tubular member according to known practices as are generally known in the art.

Tubular members as may be formed from the thermoplastic composition can include flow lines for oil and gas, for instance as may be utilized in off-shore and on-shore oil and gas fields and transport. Flowlines that incorporate the thermoplastic composition may be single-layered or multi-layered. When considering a multi-layer flowline, the thermoplastic composition can be utilized to form an inner barrier layer of the flowline, but it should be understood that thermoplastic composition layers of a multi-layer flowline are in no way limited to barrier layers and one or more other layers of a multi-layer flowline may incorporate the thermoplastic composition.

The flowlines can be utilized according to known practice in any gas and oil facility as is generally known in the art. Flexible risers including the thermoplastic composition can have any suitable configuration. By way of example, they can be designed bonded or unbounded risers and can have a steep S or lazy S configuration or alternatively a steep wave or lazy wave configuration as are known in the art. Standard buoyancy modules may be utilized in conjunction with the flexible risers to develop the desired configuration as is known.

Referring to FIG. 6, one embodiment of a flexible riser 800 that can incorporate the thermoplastic composition is illustrated. As shown, the riser 800 has several concentric layers. An innermost layer is generally termed the carcass 802 and can be formed of helically wound stainless steel strip so as to provide resistance against external pressures. The carcass 802 is generally a metal (e.g., stainless steel) tube that supports the adjacent barrier layer 806 and prevents riser collapse due to pressure or loads applied during operation. The bore of the flexible riser 800 can vary depending upon the fluid to be carried by the riser. For instance, the riser 800 can have a smooth bore when intended for use to carry a supporting fluid such as an injection fluid (e.g., water and/or methanol) and can have a rough bore when utilized to carry production fluids (e.g., oil and gas). The carcass, when present, can generally be between about 5 and about 10 millimeters in thickness. According to one embodiment, the carcass can be formed by helically wound stainless steel strips that interlock with one another to form the strong, interconnected carcass.

The barrier layer 806 is immediately adjacent the carcass 802. The barrier layer can be formed of the thermoplastic composition and provides strength, conductivity and flexibility while preventing permeation of the fluid carried by the riser through the riser wall. In addition, the barrier layer 806 formed of the thermoplastic composition can resist degradation by both the fluid carried by the riser (e.g., the production fluid, the injection fluid, etc.) as well as by temperature conditions under which the riser is utilized. The barrier layer 806 can generally be between about 3 and about 10 millimeters in thickness and can be extruded from a melt over the carcass 2.

The riser 800 will also include an outer layer 822 that provides an external sleeve and an external fluid barrier as well as providing protection to the riser from external damage due to, e.g., abrasion or encounters with environmental materials. The outer layer 822 can be formed of a polymeric material such as the thermoplastic composition or a high density polyethylene that can resist both mechanical damage and intrusion of seawater to the inner layers of the riser. According to one embodiment, the outer layer 822 can be a composite material that includes a polymeric material in conjunction with a reinforcement material such as carbon fibers, carbon steel fibers, or glass fibers.

A hoop strength layer 804 can be located external to the barrier layer to increase the ability of the riser to withstand hoop stresses caused by forced applied to the riser wall by a pressure differential. The hoop strength layer can generally be a metal layer formed of, e.g., a helically wound strip of carbon steel that can form a layer of from about 3 to about 7 millimeters in thickness. The hoop strength layer can resist both internal pressure and bending of the riser. In one embodiment, the carbon steel strip that forms the hoop strength layer 804 can define an interlocking profile, for instance an S- or Z-cross-sectional configuration, such that adjacent windings interlock with one another to form a stronger layer. In one embodiment, the hoop strength layer can include multiple materials for added strength. For example, in an embodiment in which design and pressure requirements call for higher burst strengths, a second flat metal strip can be helically wound over the interlocked metal strips of the hoop strength layer to provide additional strength for this layer. An intervening polymeric layer such as an anti-wear layer discussed further herein can optionally be located between the two layers of the hoop strength layer as well.

Additional strength layers 818 and 820 can be formed of helically-wound metal (generally carbon steel) strips. The strength layers 818 and 820 can be separated from the hoop strength layer 804 and from each other by polymeric anti-wear layers 817 and 819. The strength layers 818 and 820 can provide additional hoop strength as well as axial strength to the riser. Though the riser 800 includes two strength layers 818, 820, it should be understood that a riser may include any suitable number of strength layers, including no strength layers, one, two, three, or more strength layers. In general, the helically wound metal strips of strength layers 818 and 820 will overlap but need not interlock. As such, the strength layers 818, 820 may have a width of from about 1 millimeter to about 5 millimeters.

The intervening anti-wear layers 817, 819 can be formed of the thermoplastic composition or alternatively can be formed of other polymers such as a polyamide, a high density polyethylene, or the like. In one embodiment, the anti-wear layers 817, 819 can be a composite material that includes unidirectional fibers, for instance carbon or glass fibers. For instance, the anti-wear layers 817, 819 can be formed of a polymer tape or fiber-reinforced polymer tape such as a pultruded polymer tape or ribbon that is helically wound over each strength layer. The anti-wear layers 817, 819 can prevent wear of the adjacent strength layers that can come about due to motion of the strips forming the layers. The anti-wear layers 817, 819 can also prevent birdcaging of the adjacent layers. As with the strength layers 818, 820 of the riser 800, the number of anti-wear layers is not particularly limited, and a riser can include no anti-wear layers, one anti-wear layers, or multiple anti-wear layers depending upon the depth and local environment in which the riser will be utilized, the fluid to be carried by the riser, and so forth. The anti-wear layers 817, 819, can be relatively thin, for instance between about 0.2 and about 1.5 millimeters.

A riser may include additional layers as are generally known in the art. For example, a riser may include an insulation layer, for instance immediately internal to the outer layer 822. An insulation layer, when present can be formed of a foam, fibrous mat, or any other insulation material as is known. By way of example, single or multiple layers of an insulation tape can be wound onto the outer strength layer to form an insulation layer between the outer strength layer 820 and the outer layer 822.

While the above description is for an unbounded flexible riser, it should be understood that the thermoplastic composition may likewise be utilized in forming a bonded flowline. For example, the thermoplastic composition may be utilized in forming a barrier layer and optionally one or more additional layers of a bonded flowline for use in an offshore oil and gas facility.

Other flowlines for use in an oil and gas facility, for instance jumpers, pipelines, fluid supply lines, etc., can have the same general construction as a riser 800 as illustrated in FIG. 8, or may vary somewhat as to particular layers include in the multilayer flowline. For example, an injection fluid supply line, which supplies injection fluid such as methanol, glycol, and/or water to a well head, need not meet the same performance specifications as a production riser. Accordingly, at least a portion of this flowline need not include all of the various strength-enhancing layers as the riser described above. For instance, flowlines as described herein can include the barrier layer formed of the thermoplastic composition as the innermost layer, in those embodiments in which the flowline specifications do not call for an inner carcass layer as the riser described above.

The diameters of flowlines can also vary widely as is known in the art. For instance, a production fluid riser can generally have a relatively large inner diameter, from about 5 centimeters (about 2 inches) up to about 60 centimeters (about 24 inches) or even greater in some embodiments, while flowlines that carry supporting fluids to or from the well head, the manifold, the storage facility, etc., can be larger or smaller than the production fluid flowlines. For instance, an injection fluid flowline can be smaller than a production fluid flowline, for example, between about 5 centimeters (2 inches) to about 15 centimeters (6 inches) in inner diameter.

A flowline design can vary over the length of the flowline. For instance, as the offshore flowlines reach greater depths, extend to greater offshore distances, and operate at higher pressures, the flowlines that supply supporting fluids to the wells, manifolds, etc. that directly or indirectly support the hydrocarbon product extraction can increase in complexity. Accordingly, the supporting fluids may be supplied to the equipment using flowlines that vary along their length from a flowline that is designed for, e.g., lower pressure operation to a flowline that includes additional reinforcement layers for use in a more extreme environment. As the working pressure of the system increases, the supply pressures and injection pressures also increase. This increase in supply pressure may require that the flowline assemblies also be reinforced and re-engineered around the higher pressures at those locations of the system. Thus, the flowlines may vary in design across the entire length of the line. In any case, at least a portion of the flowlines can include a barrier layer formed of the thermoplastic composition.

The thermoplastic composition may be utilized in forming all manner of tubular members as may be incorporated in a fluid handling system. In one embodiment, the thermoplastic composition may be utilized in automotive applications, for instance in hoses, tubes, etc. that may be subject to extreme temperatures as well as large temperature fluctuations during use.

A tubular member including the thermoplastic composition can exhibit excellent flexibility and heat resistance, which can be of benefit if forming a tubular member for the charge air system of a vehicle. A heat resistant tubular member for use in the air handling system can include an inner layer that includes the thermoplastic composition and an outer layer formed on an outer peripheral surface of the tubular inner layer that can include a flame retardant. For example, the outer layer can be formed by using a material containing non-halogen flame retardant.

A charge air system coupling can be formed of the thermoplastic composition that can provide a connection between various charge components of the charge air system including, without limitation, at the compressor inlet and discharge, at the charge air cooler, and/or at the turbine inlet and discharge. The flexibility and strength of the thermoplastic composition can provide for a charge air system coupling that can handle slight misalignments between components of the system as well as isolate vibration between ends of the coupling. In addition, the resistance characteristics of the thermoplastic composition can improve the coupling with regard to ozone resistance and increase the life of the component.

The thermoplastic composition may also be beneficially utilized in forming components of an exhaust system for venting exhaust from an exhaust manifold of a diesel engine. A typical exhaust system can include an exhaust line and all or a portion of the exhaust line can be formed of the thermoplastic composition.

The air brake system of a heavy duty truck may also include components formed of the thermoplastic composition. For example, a coiled air brake hose assembly can include a coiled hose that may be a single layer hose or a multi-layer hose as described above in which at least one layer includes the thermoplastic composition.

Automotive fuel lines for use in cars or trucks of any size can be formed of the thermoplastic composition. The thermoplastic composition can be processed according to standard formation techniques to form a fuel line that can be either a single layer fuel tube or a multi-layer fuel hose. Fuel lines as encompassed herein are tubular shaped members having a hollow passage therethrough that allows passage of a fluid, a liquid, a gas, or a mixture thereof, through the fuel line. Any fuel line that has a generally tubular shape and includes a hollow passage through the line (i.e., in the axial direction of the tubular member) as may be included in a vehicle engine, including both gasoline and diesel engines, may include one or more layers formed of the thermoplastic composition. For example, fuel lines encompassed herein include fuel feed lines that carry fuel from the fuel tank to the engine and can be located downstream and/or upstream of the fuel filter. Other fuel lines as may incorporate the thermoplastic composition can include, without limitation, fuel return lines, fuel bypass lines, fuel crossover lines, breather lines, evaporation lines, etc.

A fuel line that incorporates the thermoplastic composition can be a single layered tubular member or a multi-layered tubular member that incorporates the thermoplastic composition in one or more layers of the fuel line. Multi-layer fuel lines can include two, three, or more layers, as is known. Multi-layer fuel lines, similar to single layer fuel tubes, can be formed to have a wide variety of cross sectional and length dimensions, as is known in the art. In general, each layer of a multi-layer fuel line can have a wall thickness of less than about 2 millimeters, or less than about 1 millimeter; and the inner diameter of the multi-layer fuel line can generally be less than about 100 millimeters, less than about 50 millimeters, or less than about 30 millimeters.

The excellent barrier properties of the thermoplastic composition combined with the chemical resistance properties of the thermoplastic composition make it suitable for use in forming an inner layer of a multi-layer fuel line. However, the thermoplastic composition is not limited to utilization as an inner layer of a multi-layer fuel line. The high strength characteristics of the thermoplastic composition combined with the excellent barrier properties and good flexibility make the composition suitable for use in forming outer layers and/or intermediate layers of a multi-layer fuel line in addition to or alternative to forming the inner layer of the multi-layer fuel line.

Additional layers can be formed of a material that is the same or different than the thermoplastic composition that forms the inner layer. For example, intermediate layers, outer layer, and adhesive layers of a fuel line can be formed of materials as described above for tubular members as may be formed of the thermoplastic composition.

Embodiments of the present disclosure are illustrated by the following examples that are merely for the purpose of illustration of embodiments and are not to be regarded as limiting the scope of the invention or the manner in which it may be practiced. Unless specifically indicated otherwise, parts and percentages are given by weight.

### Formation and Test Methods

Injection Molding Process:

Tensile bars are injection molded to ISO 527-1 specifications according to standard ISO conditions.

Tensile Properties:

Tensile properties including tensile modulus, tensile stress at break, tensile elongation at break, etc. are tested according to ISO Test No. 527 (technically equivalent to ASTM D638). Modulus, strain, and strength measurements are made on the same test strip sample having a length of 80 mm, thickness of 10 mm, and width of 4 mm. The testing temperature is 23° C., and the testing speeds are 5 or 50 mm/min.

Flexural Properties:

Flexural properties including flexural strength and flexural modulus are tested according to ISO Test No. 178 (technically equivalent to ASTM D790). This test is performed on a 64 mm support span. Tests are run on the center portions of uncut ISO 3167 multi-purpose bars. The testing temperature is 23° C. and the testing speed is 2 mm/min.

Notched Charpy Impact Strength:

Notched Charpy properties are tested according to ISO Test No. ISO 179-1) (technically equivalent to ASTM D256, Method B). This test is run using a Type A notch (0.25 mm base radius) and Type 1 specimen size (length of 80 mm, width of 10 mm, and thickness of 4 mm). Specimens are cut from the center of a multi-purpose bar using a single tooth milling machine. The testing temperature is 23° C., −30° F., or −40° F. as reported below.

Unnotched Charpy Impact Strength:

Unnotched Charpy properties are tested according to ISO Test No. 180 at 23° C. (technically equivalent to ASTM D256). The test is run using a Type 1 specimen (length of 80 mm, width of 10 mm and thickness of 4 mm). Specimens are cut from the center of a multi-purpose bare using a single tooth milling machine. The testing temperature is 23° C.

Permeation Resistance:

The fuel permeation studies were performed on samples according to SAE Testing Method No. J2665. For all samples, stainless-steel cups were used. Injection molded plaques with a diameter of 3 inches (7.6 centimeters) were utilized as test samples. The thickness of each sample was measured in 6 different areas. An O-ring Viton® fluoroelastomer was used as a lower gasket between cup flange and sample (Purchased from McMaster-Carr, cat#9464K57, A75). A flat Viton® fluoroelastomer (Purchased from McMaster-Carr, cat#86075K52, 1/16″ thickness, A 75) was die-cut to 3 inch (7.6 cm) OD and 2.5 inch (6.35 cm) ID, and used as the upper gasket between the sample and the metal screen. The fuel, about 200 ml, was poured into the cup, the cup apparatus was assembled, and the lid was finger-tightened. This was incubated in a 40° C. oven for 1 hour, until the vapor pressure equilibrated and the lid was tightened to a torque 15 in-lb. The fuel loss was monitored gravimetrically, daily for the first 2 weeks followed by twice a week for the rest of the testing period. A blank run was done in the same manner with an aluminum disk (7.6 cm diameter, 1.5 mm thickness) and the result was subtracted from the samples. All samples were measured in duplicate. The normalized permeation rate was calculated following an equilibration period. The permeation rate for each sample was obtained from the slope of linear regression fitting of daily weight loss (gm/day). The normalized permeation rate was calculated by dividing the permeation rate by the effective permeation area and multiplying by average thickness of specimen. The average permeation rates are reported.

Salt Resistance:

For testing resistance to zinc chloride, tensile bar samples were immersed in a 50% aqueous solution (by weight) of zinc chloride for 200 hours at 23±2° C. Following the samples were tested for Charpy notched impact strength as described at −30° C.

For testing resistance to calcium chloride, tensile bar samples were immersed in a 50% aqueous solution (by weight) of calcium chloride for 200 hours at 60±2° C. and held for an additional 200 hours out of solution at 60±2° C. Following, the samples were tested for Charpy notched impact strength as described at −30° C.

Hydrocarbon Volume Uptake:

Absorption and diffusion testing was performed using the tab ends cut from supplied tensile bars. Each material was immersed in Brent crude oil, hydrocarbon/water mixture (and in a one-off test to hydrocarbon only). Rates and amounts of liquid absorbed were measured. Fuels tested included CE10 (10 wt. % ethanol, 45 wt. % toluene, 45 wt. % iso-octane), CM15A (15 wt. % methanol and 85 wt. % oxygenated fuel), and methanol.

All exposure testing was conducted at 130° C. for a period of two weeks utilizing an air-circulating oven, air having been removed from the test vessel by purging with nitrogen; the test being conducted at vapor pressure.

Tensile Bar Surface Resistivity:

Surface resistivity was tested according to ASTM D257. Resistivity measurements are made on the same test strip sample having a length of 80 mm, thickness of 10 mm, and width of 4 mm. The testing temperature is 23° C. Silver paint was as the electrode system.

Burst Pressure:

Monolayer tubes were extruded having an 8 millimeter outer diameter and a wall thickness of 1 millimeter. The tubes were subjected to burst pressure testing according to SAE J2260. Internal pressure of tubes was increases at a rate of 7 MPa/min±1 MPa/min until tubes burst.

Fuel Tube Pull Off:

The monolayer tubes were subjected to pull off testing according to SAE J2045. Test sample consisted of a length of tubing, 500 mm long, with fitting inserted at both ends. A tensile load at a constant rate of 50 mm/min was applied to fittings. Load was continually applied until one or more fittings were separated from the tube.

Extractable Content:

Extractable content was determined by taking 5 grams of sample and placing into an extraction thimble into the extraction chamber. Soxhlet apparatus was assembled. Samples were refluxed in Ethanol for 18 hours collecting and emptying solvent. At the end of the 18 hours the Ethanol was evaporated off using a Hot Plate. Sample was weighed again to determine the extractable content.

Heat Aging:

Samples were placed in an oven set to the desired temperature and aged for the desired time. Samples were removed and tested as needed after the being at temperature for the desired length of time.

### Example 1

Materials utilized to form the compositions included the following:

Polyarylene sulfide: Fortron® 0214 linear polyphenylene sulfide available from Ticona Engineering Polymers of Florence, Ky.

Impact Modifier: LOTADER® AX8840—a random copolymer of ethylene and glycidyl methacrylate available from Arkema, Inc.

Crosslinking Agent: Terephthalic Acid

Lubricant: Glycolube® P available from Lonza Group Ltd.

Carbon Nanotubes: Nanocyl® NC7000 from Nanocyl SA

Materials were melt mixed using a Coperion co-rotating, fully-intermeshing, twin-screw extruder with an overall L/D of 40 and ten temperature control zones including one at the die. A high shear screw design was used to compound the additives into a resin matrix. The polyarylene sulfide, impact modifier, carbon nanotubes, and lubricant were fed to the main feed throat in the first barrel by means of a gravimetric feeder. Upon melting and mixing of the above ingredients, the crosslinking agent was fed using a gravimetric feeder at barrel 6. Materials were further mixed then extruded through a strand die. The strands were water-quenched in a bath to solidify and granulated in a pelletizer.

Compositions of the samples are provided in Table 1, below. Amounts are provided as weight percentages based upon the weight of the sample.

TABLE 1

| Component | Addition Point | Sample 1 | Sample 2 | Sample 3 |
|---|---|---|---|---|
| Lubricant | main feed | 0.3 | 0.3 | 0.3 |
| Crosslinking Agent | barrel 6 | 1.0 | 1.0 | 1.0 |
| Impact Modifier | main feed | 15.0 | 15.0 | 15.0 |
| Polyarylene Sulfide | main feed | 81.7 | 81.2 | 80.7 |
| Carbon Nanotubes | main feed | 2.0 | 2.5 | 3.0 |
| Total | | 100.0 | 100.0 | 100.0 |

Following formation, samples were tested for a variety of physical characteristics. Results are provided in Table 2, below.

TABLE 2

| | Sample 1 | Sample 2 | Sample 3 |
|---|---|---|---|
| Tensile Bar Surface | 10⁵ | 10⁵ | 10⁴ |
| Resistivity (Ω) | | | |
| Tensile Modulus (MPa, 50 | 2446 | 2571 | 2580 |
| mm/min) | | | |
| Tensile Break Stress (MPa) | 56.2 | 58.2 | 58.7 |
| Tensile Elongation at Break | 27 | 24.7 | 19.3 |
| (%) | | | |
| Notched Charpy Impact | 39.2 | 38.0 | 23.2 |
| Strength at 23° C. (kJ/m²) | | | |

The conductivity of Sample 2 was further investigated by soaking an extruded film sample in a fuel of 50% isooctane and 50% toluene by volume (Fuel C) at 60° C. and monitoring the surface resistivity as a function of time. The results are shown in FIG. 8. As can be seen, there was negligible change in the surface resistivity after immersion.

### Example 2

Materials utilized to form the compositions included the following:

Polyarylene sulfide: Fortron® 0214 linear polyphenylene sulfide available from Ticona Engineering Polymers of Florence, Ky.

Impact Modifier: LOTADER® AX8840—a random copolymer of ethylene and glycidyl methacrylate available from Arkema, Inc.

Crosslinking Agent: Terephthalic Acid

Lubricant: Glycolube® P available from Lonza Group Ltd.

Materials were melt mixed using a WLE-25 mm at 310° C. followed by pelletizing. The polyarylene sulfide, impact modifier and lubricant were fed to the main feed throat in the first barrel by means of a gravimetric feeder. The crosslinking agent was fed using a gravimetric feeder at barrel 6. Sample compositions are as found in Table 3, below.

TABLE 3

| | Addition | Sample | Sample | Sample | Sample |
|---|---|---|---|---|---|
| | Point | 4 | 5 | 6 | 7 |
| Lubricant | main | 0.3 | 0.3 | 0.3 | 0.3 |
| | feed | | | | |
| Crosslinking Agent | barrel 6 | 1.0 | 1.25 | 1.25 | 1.10 |
| Impact Modifier | main | 15.0 | 25.0 | 30.0 | 20.0 |
| | feed | | | | |
| PolyaryleneSulfide | main | 83.7 | 73.45 | 68.45 | 78.6 |
| | feed | | | | |
| Total | | 100.0 | 100.0 | 100.0 | 100.0 |

Following formation, tensile bars were formed and tested for a variety of physical characteristics. Results are provided in Table 4, below.

TABLE 4

| | Sample | Sample | Sample | Sample |
|---|---|---|---|---|
| | 4 | 5 | 6 | 7 |
| Tensile Modulus (MPa, 50 | 2200 | 1672 | 1231 | 2006 |
| mm/min) | | | | |
| Tensile Break Stress (MPa) | 48 | 42 | 40 | 46 |
| Elongation at Break (%) | 39 | 102 | 88 | 75 |
| Flexural Modulus (MPa) | 2468 | 1750 | 1314 | 1917 |
| Notched Charpy Impact | 41 | 54 | 51 | 46 |
| Strength at 23° C. (kJ/m²) | | | | |
| Notched Charpy Impact | 10 | 24 | 20 | 15 |
| Strength at −30° C. (kJ/m²) | | | | |

Samples were then extruded into monolayer tubes with an 8 mm outer diameter and a wall thickness of 1 mm. The tubes were subjected to a variety of standard automotive fuel tube tests as listed in SAE J2260. Testing results are shown in Table 5, below.

TABLE 5

| | Sample | Sample | Sample | Sample |
|---|---|---|---|---|
| | 3 | 4 | 5 | 6 |
| Ambient Burst Pressure | 1335 | 1326 | 1238 | 1358 |
| (psi) | | | | |
| Burst Pressure | 985 | 944 | 668 | 993 |
| (115° C. psi) | | | | |
| Burst Pressure | 731 | 679 | 461 | 874 |
| (150° C. psi) | | | | |
| Kink and Burst Pressure | 1327 | 1322 | 1243 | 1431 |
| (psi) | | | | |
| Burst Pressure after cold | 1338 | 1294 | 1213 | 1305 |
| impact (psi) | | | | |
| Ambient Pull Off (N) | 798 | 866 | 572 | 750 |
| Pull Off at 85° C. (N) | 376 | 537 | 580 | 552 |
| CE10 Permeation | 0.04 | 0.06 | 2.51 | 0.26 |
| (gm/day*m²) | | | | |
| CM15A Permeation | 0.11 | 0.27 | 2.29 | 1.51 |
| (gm/day*m²) | | | | |
| Methanol Permeation | 0.05 | 0.25 | 0.41 | 2.35 |
| (gm/day*m²) | | | | |
| Charpy Unnotched | 233 | NB | NB | NB |
| Impact Strength after | | | | |
| CaCl₂ exposure (kJ/m2) | | | | |
| Extractable Content | 0.1575 | 0.1299 | 0.1238 | 0.1219 |
| (wt. %) | | | | |
| Length Change after | 0.54 | 0.39 | 0.4 | 0.88 |
| heat aging (%) | | | | |
| Outer diameter change | 0.14 | 0.25 | 0.16 | 0.22 |
| after heat aging (%) | | | | |
| Wall thickness change | 0.05 | 0.48 | 0.71 | 0.28 |
| after heat aging (%) | | | | |

As can be seen, the tubes had a high burst pressure, excellent chemical resistance, very low permeation, and excellent temperature resistance.

These and other modifications and variations to the present disclosure may be practiced by those of ordinary skill in the art, without departing from the spirit and scope of the present disclosure. In addition, it should be understood the aspects of the various embodiments may be interchanged, either in whole or in part. Furthermore, those of ordinary skill in the art will appreciate that the foregoing description is by way of example only, and is not intended to limit the disclosure.

What is claimed is:

1. A thermoplastic composition including a polyarylene sulfide, a crosslinked impact modifier, and carbon nanotubes, the thermoplastic composition including the carbon nanotubes in an amount from about 0.1% to about 5% by weight of the thermoplastic composition, wherein the thermoplastic composition has a surface resistivity of about 10⁵ ohm or less

2. The thermoplastic composition according to claim 1, wherein the thermoplastic composition has a surface resistivity of about 10⁴ ohm or less.

3. The thermoplastic composition according to claim 1, wherein the thermoplastic composition exhibits a permeation resistance to fuel or a fuel source of less than about 10 g-mm/m²-day as determined according to SAE Testing Method No. J2665.

4. The thermoplastic composition according to claim 1, wherein the polyarylene sulfide is a polypropylene sulfide or is a reactively functionalized polyarylene sulfide.

5. The thermoplastic composition according to claim 1, further comprising one or more additives, the one or more additives comprising fillers, a UV stabilizer, a heat stabilizer, a lubricant, or a colorant.

6. The thermoplastic composition according to claim 1, wherein the crosslinked impact modifier comprises the reaction product of an epoxy functionality of the impact modifier or a maleic anhydride functionality of the impact modifier and a crosslinking agent.

7. The thermoplastic composition according to claim 1, wherein the thermoplastic composition is free of plasticizers.

8. A tubular member comprising the thermoplastic composition according to claim 1.

9. The tubular member of claim 8, wherein the tubular member has an ambient burst pressure of about 6 megapascals or greater as determined according to SAE Testing Method No. J2665 for an 8 millimeter outside diameter tube.

10. The tubular member of claim 8, wherein the tubular member has a burst pressure at 115° C. of about 2 megapascals or greater as determined according to SAE Testing Method No. J2665 for an 8 millimeter outside diameter tube.

11. The tubular member of claim 8, wherein the tubular member has a burst pressure at 150° C. of about 2 megapascals or greater as determined according to SAE Testing Method No. J2665 for an 8 millimeter outside diameter tube.

12. The tubular member of claim 8, wherein the tubular member has a kink and burst pressure of about 4.5 megapascals or greater as determined according to SAE Testing Method No. J2665 for an 8 millimeter outside diameter tube.

13. The tubular member of claim 8, wherein the tubular member exhibits an ambient pull off of about 450 Newtons or greater as determined according to SAE Testing Method No. J2045 for an 8 millimeter outside diameter tube.

14. The tubular member of claim 8, wherein the tubular member exhibits a pull off at 85° C. of about 115 Newtons or greater as determined according to SAE Testing Method No. J2045 for an 8 millimeter outside diameter tube.

15. The tubular member of claim 8, wherein the tubular member is an extruded member, an injection molded member, or a blow-molded member.

16. The tubular member of claim 8, wherein the tubular member is a multilayered tubular member comprising an inner layer, the inner layer including the thermoplastic composition.

17. The tubular member of claim 8, wherein the tubular member is a single layer tubular member.

18. The tubular member of claim 8, wherein the tubular member is a fuel line.

19. The tubular member of claim 8, wherein the tubular member comprises a wrapped tape that includes the thermoplastic composition.

20. The tubular member of claim 8, wherein the tubular member is an oil or gas flow line.

21. The tubular member of claim 8, wherein the tubular member is a bonded or unbonded riser.

22. The tubular member of claim 8, wherein the tubular member is an automotive component.

23. The tubular member of claim 22, wherein the tubular member is automotive fuel line.

24. A method for forming a thermoplastic composition comprising:
feeding polyarylene sulfide to a melt processing unit;
feeding an impact modifier to the melt processing unit, the polyarylene sulfide and the impact modifier mixing in the melt processing unit such that the impact modifier becomes distributed throughout the polyarylene sulfide, the impact modifier comprising a reactive functionality;
feeding an amount of carbon nanotubes to the melt processing unit, the carbon nanotubes being fed to the melt processing unit in an amount of from about 0.1 wt. % to about 5 wt. % by weight of the thermoplastic composition; and
feeding a crosslinking agent to the melt processing unit, the crosslinking agent being fed to the melt processing unit following distribution of the impact modifier throughout the polyarylene sulfide, the crosslinking agent comprising reactive functionality that is reactive to the reactive functionality of the impact modifier.

25. The method according to claim 24, further comprising feeding a disulfide compound to the melt processing unit, the disulfide compound comprising reactive functionality at one or more terminal ends of the disulfide compound.

26. The method according to claim 25, wherein the reactive functionality of the disulfide compound is the same as the reactive functionality of the crosslinking agent.

27. The method according to claim 25, wherein the disulfide compound and the crosslinking agent are added in conjunction with one another.

28. The method according to claim 24, further comprising forming a tubular member from the thermoplastic composition.
